(19) United States
(12) Patent Application Publication
(10) Pub. No.: US 2015/0370976 A1
(43) Pub. Date: Dec. 24, 2015

(54) Systems and Methods for Determining Coverage for Medication or Services Related to Specific Conditions or Levels of Care

(71) Applicant: MCKESSON CORPORATION, San Francisco, CA (US)

(72) Inventors: Roger G. Pinsonneault, Alpharetta, GA (US); Monique L. Irmen, Richmond, MO (US)

(21) Appl. No.: 14/312,424

(22) Filed: Jun. 23, 2014

(51) Int. Cl. G06F 19/00

(52) U.S. Cl. CPC G06F 19/328; G06F 19/322

(57) ABSTRACT

Systems and methods are provided to determine if a prescription is for patient specific condition or level of care requiring a coverage determination such as hospice care or ESRD for a patient as part of healthcare transaction processing. A service provider computer can receive a healthcare transaction from a healthcare provider that includes a medication identifier and a patient identifier. The service provider computer can determine, based on the medication identifier and/or the patient identifier if the healthcare transaction is for a medication related to a specific condition or level of care. The service provider computer can also generate a rejection response to the healthcare transaction based at least in part on the positive determination that the healthcare transaction is for a medication related to the specific condition or level of care, and can transmit the rejection response to the healthcare provider computer for further action if necessary.

### TECHNICAL FIELD

Aspects of the disclosure relate generally to the determination of patient healthcare insurance benefits, and more particularly, to systems and methods for determining a correct claims payor for a specific condition or level of care requiring a coverage determination, such as end stage renal disease (ESRD), or under hospice care to which payment may be made by differing entities depending on either diagnosis or type of drug being prescribed.

### BACKGROUND

Medicare Part D is a federal healthcare program that administers the prescription drug program for Medicare beneficiaries. Patients can receive Medicare Part D prescription coverage if they are also signed up for Medicare Part A and/or Part B. Medications and other biologics covered under the Medicare Part A per-diem payment to a hospice organization or included in the Part B bundled payment to a terminal patient care facility, such as an ESRD dialysis facility are not covered under Medicare Part D. However, since many Medicare Part D reimbursement levels for prescribed medications, products, and services is higher than the reimbursement rates under Medicare Parts A & B for the same medications, products, or services, certain prescribers may attempt to obtain reimbursement under Medicare Part D when the prescription should have been submitted under one of Medicare Parts A and B. This may also occur in order to increase the profitability of the bundle/per diem payment or because the ESRD facility does not have the ability to provide outpatient oral medications. In addition, some prescribers may just mistakenly attempt to obtain reimbursement under Medicare Part D when the prescription should have been submitted under one of Medicare Parts A and B. While a claim under Medicare Part D may initially be paid, the Part D Plan or Centers for Medicare & Medicaid Services (CMS) may subsequently audit the transaction and may require the Part D plan to delete the prescription drug event (PDE) submitted to the Centers for Medicare and Medicaid Services (CMS). This may put the pharmacy at risk if the Part D Plan recoups the cost of the medication from the pharmacy as it is unlikely that the pharmacy can go back to the patient for payment of the medication.

### BRIEF DESCRIPTION OF THE DRAWINGS

Reference will now be made to the accompanying drawings, which are not necessarily drawn to scale, and wherein:

FIG. 1 illustrates an example overview of a system that facilitates determining the correct claims payor/processor for medication and other product/service claims potentially related to patient care that may require a coverage determination for Medicare Part D Plans, such as ESRD or hospice care, according to one exemplary embodiment of the disclosure.

FIG. 2A is a diagram of an example data flow for evaluating claims to determine if they are for medications, products, or services related to patient care that may require a coverage determination for Medicare Part D Plans, such as ESRD or hospice care as part of the processing of the healthcare transaction, according to one exemplary embodiment of the disclosure.

FIG. 2B is a diagram of another example data flow for evaluating claims to determine if they are for medications, products, or services related to patient care that may require a coverage determination for Medicare Part D Plans, such as ESRD or hospice care as part of the processing of the healthcare transaction processed through one or more service providers, according to an alternative exemplary embodiment of the disclosure.

FIGS. 3A and 3B are a flow chart of an example method for evaluating claims to determine if they are for medications, products, or services related to patient care that may require a coverage determination for Medicare Part D Plans, such as ESRD or hospice care as part of the processing of the healthcare transaction, according to one exemplary embodiment of the disclosure.

FIG. 4A is a diagram of another example data flow for evaluating e-prescription transactions to determine if they are for medications, products, or services related to patient care that may require a coverage determination for Medicare Part D Plans, such as ESRD or hospice care as part of the processing of the e-prescription transaction, according to one exemplary embodiment of the disclosure.

FIG. 4B is a diagram of another example data flow for evaluating e-prescription transactions to determine if they are for medications, products, or services related to patient care that may require a coverage determination for Medicare Part D Plans, such as ESRD or hospice care as part of the processing of the e-prescription transaction processed through one or more service providers, according to an alternative exemplary embodiment of the disclosure.

FIGS. 5A and 5B are a flow chart of an example method for evaluating e-prescription transactions to determine if they are for medications, products, or services related to patient care that may require a coverage determination for Medicare Part D Plans, such as ESRD or hospice care as part of the processing of the e-prescription transaction, according to another exemplary embodiment of the disclosure.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate determining the correct claims payor/processor for medication and other product or service claims potentially related to patient care that may require a coverage determination for Medicare Part D Plans, such as ESRD or hospice care, as part of the processing of the healthcare transaction in real-time or near real-time. For example, a pharmacy or another healthcare provider can transmit a healthcare claim transaction for adjudication by a claims processor, via a healthcare provider computer, to a service provider computer. The healthcare claim transaction can be for a prescribed medication, product, or service for a patient and can be generated in response to receipt of a prescription (electronic or otherwise) for the patient. The healthcare claim transaction can be received by the service provider computer and, based on information in the transaction, the service provider computer can determine if the requested medication, product, or service is related to or may potentially be related to patient care that may require a coverage determination for Medicare Part D Plans, such as ESRD care or care provided by a hospice organization or medications, products, or services for the treatment of ESRD or another terminal disease. The service provider computer can further determine if the identified claims processor in the healthcare claim transaction may not be the proper claims processor for situations where the requested medication, product, or service is or is potentially related to patient care that may require a coverage determination for Medicare Part D Plans, such as ESRD or hospice care. Further, the service provider computer can generate a rejection of the healthcare claim transaction based on the determination that the requested medication, product, or service is or is potentially related to patient care that may require a coverage determination for Medicare Part D Plans, such as ESRD or hospice care. The rejection by the service provider may also include a request for additional information as well as an override code confirming the medication, product, or service is not related to the treatment of a patient that may require a coverage determination for Medicare Part D Plans, such as ESRD or hospice care. The request for additional information can include a request for a diagnosis code or other diagnosis identifying information and/or the inclusion of the override code to be submitted in a modified healthcare claim transaction. The service provider computer transmits the rejected healthcare claim transaction to the originating healthcare provider computer. The pharmacy or other healthcare provider can include the necessary information and resubmit the modified healthcare claim transaction to the service provider computer via the healthcare provider computer. The service provider computer can evaluate the modified healthcare claim transaction to determine if it includes an override code. In addition, or alternatively, the service provider computer can identify the diagnosis code or other diagnosis identifying information in the modified healthcare claim transaction. The service provider computer can determine if the diagnosis code is one associated with patient care that may require a coverage determination for Medicare Part D Plans, such as ESRD or hospice care. The service provider computer can transmit the modified healthcare claim transaction to the claims processor computer associated with the claims processor identified in the modified healthcare claim transaction based on, for example, determining that the modified healthcare transaction includes the override code and/or the diagnosis code is not for a diagnosis associated with patient care that may require a coverage determination for Medicare Part D Plans, such as ESRD or hospice care. Upon adjudication by the claims processor computer, the service provider computer can receive the adjudicated response from the claims processor computer. The service provider computer can store all or a portion of the information from the modified healthcare claim transaction and/or the adjudicated response to the modified healthcare claim transaction in a data storage device and can forward the adjudicated response to the modified healthcare claim transaction to the healthcare provider computer from which the modified healthcare claim transaction originated.

In an alternate example, a prescriber of medications, products, and/or services to patients, such as a physician, physician's assistant, nurse, or any other person permitted to prescribe medication, can transmit a healthcare transaction, such as an e-prescription transaction, via a healthcare provider computer, to a service provider computer for submission to a pharmacy computer. The healthcare transaction can be an e-prescription transaction for a prescribed medication, product, or service for a patient. The e-prescription transaction can be received by the service provider computer and, based on information in the transaction, the service provider computer can determine if the requested medication, product, or service is related to or may potentially be related to patient care that may require a coverage determination for Medicare Part D Plans, such as ESRD or hospice care or medications, products, or services for the treatment of ESRD or another terminal disease. The service provider computer can generate a rejection of the e-prescription transaction based on the determination that the requested medication, product, or service is or is potentially related to patient care that may require a coverage determination for Medicare Part D Plans, such as ESRD or hospice care. The rejection by the service provider may also include a request for additional information as well as an override code confirming the medication, product, or service is not related to patient care that may require a coverage determination for Medicare Part D Plans, such as ESRD or hospice care for the patient. The request for additional information can include a request for a diagnosis code or other diagnosis identifying information and/or the inclusion of the override code to be submitted in a modified e-prescription transaction. The service provider computer transmits the rejected e-prescription transaction to the originating healthcare provider computer for the prescriber. The prescriber can include the necessary information and resubmit the modified e-prescription transaction to the service provider computer via the healthcare provider computer. The service provider computer can evaluate the modified e-prescription transaction to determine if it includes an override code. In addition, or alternatively, the service provider computer can identify the diagnosis code or other diagnosis identifying information in the modified e-prescription transaction. The service provider computer can determine if the diagnosis code is one associated with the treatment of ESRD or an ESRD-related condition for the patient, a terminal condition for the patient or hospice care for the patient. The service provider computer can transmit the modified e-prescription transaction to a pharmacy computer associated with a pharmacy identified in the modified e-prescription transaction based on, for example, determining that the modified e-prescription transaction includes the override code and/or the diagnosis code is not for a diagnosis associated with the treatment of ESRD or and ESRD-related condition for the patient, a terminal condition for a patient, or hospice care for the patient.

System Overview

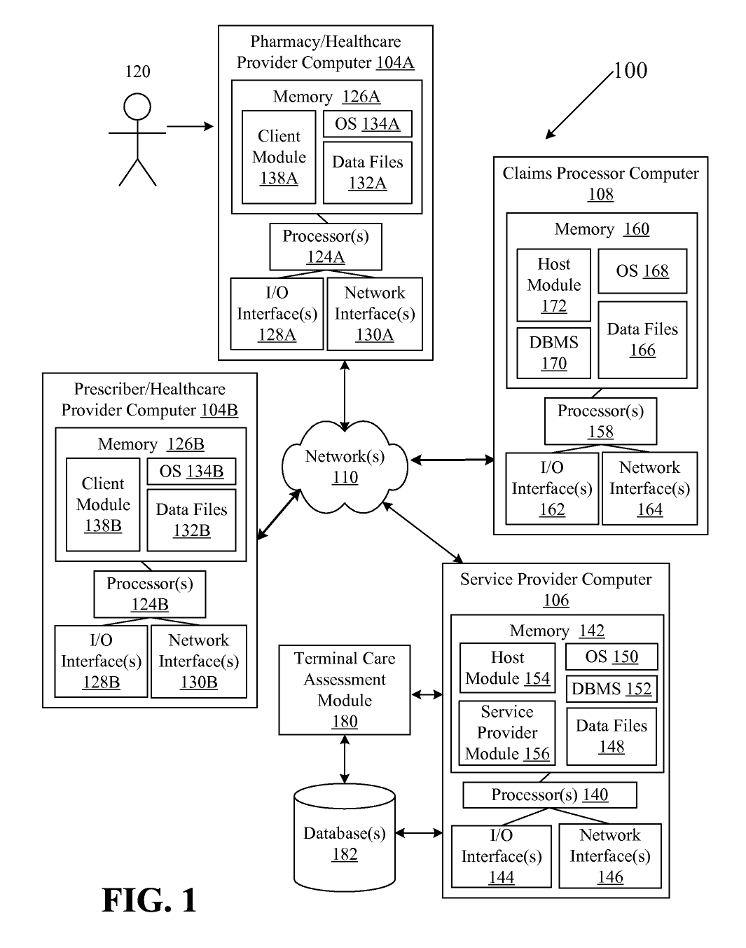

FIG. 1 illustrates an example system 100 supporting healthcare transactions, electronic prescription ordering activities, prescription billing activities, and patient coverage eligibility verifications according to one example embodiment. The exemplary system 100 facilitates determining the correct claims processor for medication and other product or service claims potentially related to patient care that may require a coverage determination for Medicare Part D Plans, such as ESRD or hospice care as part of the processing of the healthcare transaction, including, but not limited to, an eligibility verification request, predetermination of benefits transaction, healthcare claim transaction, prescription claim or billing request, healthcare order transaction, or e-prescription transaction (e.g., electronic prescription order transaction, e-script, or e-prescription), and will now be described illustratively with respect to FIG. 1. As shown in FIG. 1, the system 100 may include at least one healthcare provider computer 104, at least one service provider computer 106, and at least one claims processor computer 108. As shown in FIG. 1, multiple healthcare provider computers 104A and 104B are presented by way of example and may be referred to individually or collectively as “healthcare provider computer 104” hereinafter. Alternatively, each of the pharmacy/healthcare provider computer 104A and prescriber/healthcare provider computer 104B may be specifically discussed with reference to designations on FIG. 1.

As desired, each of the healthcare provider computers 104A and 104B, service provider computer 106, and/or claims processor computer 108 may include one or more processing devices that may be configured for accessing and reading associated computer-readable media having stored thereon data and/or computer-executable instructions for implementing various methods, including those described herein.

Additionally, in certain exemplary embodiments, the service provider computer 106 may be in communication with one or more terminal care assessment modules 180, which may access and/or be in communication with one or more suitable data storage devices, such as database 182. The terminal care assessment module 180 may receive healthcare transactions or all or a portion of the data from healthcare transactions from the service provider computer 106. Upon receipt of the healthcare transaction data, the terminal care assessment module 180 may evaluate the data to determine if the healthcare transaction is for a medication, product, or service that is or is potentially related to patient care that may require a coverage determination for Medicare Part D Plans, such as ESRD or hospice care. Further, the terminal care assessment module 180 can evaluate the data from the healthcare transaction to determine if the patient identified in the healthcare transaction is a patient identified as receiving terminal care (e.g., care for ESRD, another terminal disease, or receiving care from a hospice organization). In addition, the terminal care assessment module 180 can determine if the healthcare transaction includes a diagnosis code and if that diagnosis code is for or associated with ESRD or an ESRD-related condition, or providing terminal care to a patient. Further, the terminal care assessment module 180 can evaluate the healthcare transaction to determine if the transaction includes an override code that indicates the medication, product, or service requested in the healthcare transaction is not for the treatment of a disease or condition associated with patient care that may require a coverage determination for Medicare Part D Plans, such as ESRD, another terminal disease, or hospice care. The terminal care assessment module 180 can communicate its analysis to the service provider computer 106 or it can, based on the analysis, determine whether to reject the healthcare transaction and return it to the healthcare provider computer 104 from which it was initially sent, or pass along the healthcare transaction to the claims processor computer 108 or the pharmacy/healthcare provider computer 104A depending on the type of healthcare transaction. While FIG. 1 shows the terminal care assessment module 180 as being separate from the service provider computer 106, in certain example embodiments, the terminal care assessment module 180 is part of the service provider computer 106 and sending and receiving between the two are internal transmissions within the service provider computer 106. Furthermore, while FIG. 1 shows the terminal care assessment module 180 as a single module, in certain example embodiments, the functions/operations discussed below with regard to the terminal care assessment module 180 may be completed by multiple modules, all or a portion of which may be part of the service provider computer 106.

Generally, network devices and systems, including one or more of the healthcare provider computers 104A and 104B, service provider computer 106, terminal care assessment module 180, and claims processor computer 108 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, the healthcare provider computers 104A and 104B, service provider computer 106, claims processor computer 108, and terminal care assessment module 180 may be in communication with each other via one or more networks, such as network 110, which as described below can include one or more separate or shared private and public networks, including the Internet or a publicly switched telephone network. Each of these components—the healthcare provider computers 104A and 104B, service provider computer 106, claims processor computer 108, terminal care assessment module 180, and the network 110 will now be discussed in further detail.

Each healthcare provider computer 104 may be associated with a healthcare provider, such as, for example, a pharmacy, physician's office, hospital, clinic, hospice, etc. While the exemplary healthcare provider computers 104A and 104B reference a pharmacy (104A) and a prescriber (104B) this is for example only and is not intended to be limiting in any manner. Each healthcare provider computer 104A and 104B may be any suitable processor-driven device that facilitates the processing of healthcare requests made by patients, consumers, or prescribers and the communication of information associated with healthcare transactions to the service provider computer 106, such as a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, each healthcare provider computer 104A and 104B may be a suitable point of sale device associated with a healthcare provider. The execution of the computer-implemented instructions by either healthcare provider computer 104A and 104B may form a special purpose computer or other particular machine that is operable to facilitate the processing of healthcare requests made by patients and the communication of information associated with healthcare transactions to a service provider computer 106. Additionally, in certain example embodiments of the disclosure, the operations and/or control of each healthcare provider computer 104A and 104B may be distributed amongst several processing components.

In addition to each healthcare provider computer 104A and 104B having one or more processors 124A and 124B, each healthcare provider computer 104A and 104B may also include one or more memory devices 126A and 126B, one or more input/output (“I/O”) interfaces 128A and 128B, and one or more network interfaces 130A and 130B. The memory devices 126A and 126B may be any suitable memory device, for example, caches, read-only memory devices, random access memory devices, magnetic storage devices, removable storage devices, etc. The memory devices 126A and 126B may store data, executable instructions, and/or various program modules utilized by each respective healthcare provider computer 104A and 104B, for example, data files 132A and 132B, an operating system (“OS”) 134A and 134B, and/or a client module 138A and 138B, respectively. Each of the data files 132A and 132B may include any suitable data that facilitates the receipt and/or processing of healthcare requests by the respective healthcare provider computer 104A and 104B and the generation and/or processing of healthcare transactions that are communicated to the service provider computer 106. For example, the data files 132A and 132B may include, but are not limited to, healthcare information and/or contact information associated with one or more patients, information associated with the particular healthcare provider and/or the respective healthcare provider computer 104A and 104B, information associated with the service provider computer 106, information associated with one or more claims processors, and/or information associated with one or more healthcare transactions. The OS 134A and 134B may be any suitable software module that controls the general operation of the respective healthcare provider computer 104A and 104B. The OS 134A and 134B may also facilitate the execution of other software modules by the one or more respective processors 124A and 124B, for example, the client module 138A and 138B. The OS 134A and 134B may be, but is not limited to, Microsoft Windows®, Apple OSX™, Linux, Unix, or a mainframe operating system.

Each client module 138A and 138B may be, for example, an Internet browser or other suitable software, including a dedicated program, for interacting with the service provider computer 106. For example, a user 120, such as a pharmacist, pharmacy assistant, nurse practitioner, physician, nurse, or other pharmacy, hospital or physician's office employee, may utilize the respective client module 138A and 138B in preparing and providing a healthcare transaction, such as a healthcare claim transaction, prescription claim or billing request, healthcare order transaction, or e-prescription transaction (e.g., electronic prescription order transaction, e-script, or e-prescription), to the service provider computer 106 for delivery to: i) the appropriate claims processor computer 108 or other third-party for adjudication or other coverage/benefits determination, or ii) the appropriate other healthcare provider computer, such as from the prescriber/healthcare provider computer 104B to a pharmacy/healthcare provider computer 104A for dispensing of the prescribed medication. Each healthcare provider computer 104A and 104B may also utilize the respective client module 138A and 138B to retrieve or otherwise receive data, messages, or responses from the service provider computer 106 and/or other components of the system 100. For example, in certain example embodiments, the client module 138A and 138B may be utilized to receive a healthcare transaction, a rejection of the healthcare transaction and/or an adjudicated response to the healthcare transaction from the service provider computer 106 as will be described below.

The one or more I/O interfaces 128A and 128B may facilitate communication between the respective healthcare provider computer 104A and 104B and one or more input/output devices, for example, one or more user interface devices, such as, a display, keypad, control panel, touch-screen display, remote control, microphone, etc., that facilitate user interaction with the particular healthcare provider computer 104A and 104B. For example, the one or more I/O interfaces 128A and 128B may facilitate entry of information associated with a healthcare transaction by an employee 120 of a healthcare provider, such as a pharmacy employee, pharmacist, physician, nurse, hospital employee, or nurse practitioner affiliated with a pharmacy, hospital, physician's office, clinic, or other similar healthcare provider. The one or more network interfaces 130A and 130B may facilitate connection of the particular healthcare provider computer 104A and 104B to one or more suitable networks, for example, the network 110 illustrated in FIG. 1. In this regard, each healthcare provider computer 104A and 104B may receive and/or communicate information to other network components of the system 100, such as the service provider computer 106.

With continued reference to FIG. 1, the service provider computer 106 may include, but is not limited to, any suitable processor-driven device that is configured for receiving, processing, and fulfilling requests from the healthcare provider computers 104A and/or 104B, the terminal care assessment module 180, and/or the claims processor computer 108 relating to terminal care assessments, pharmacy, benefits, billing, electronic prescription submission, and/or other healthcare transactions and/or other activities. In certain exemplary embodiments, the service provider computer 106 may be a switch/router that routes healthcare transactions and/or other healthcare requests. For example, the service provider computer 106 may route healthcare claim transactions communicated from one of the healthcare provider computers 104A and 104B to a claims processor computer 108, such as a pharmacy benefits manager (PBM), an insurer, a Medicare payor, a Medicare Part D payor, or other third-party payor. In another example, the service provider computer 106 may route healthcare transactions communicated from a prescriber/healthcare provider computer 104B (or other prescriber of medication, products, and/or services) to the pharmacy/healthcare provider computer 104A.

In certain example embodiments, the service provider computer 106 may include a suitable host server, host module, or other software that facilitates the receipt of a healthcare transaction from a healthcare provider computer 104A and 104B and/or the routing of the received healthcare transaction to a claims processor computer 108 or pharmacy/healthcare provider computer 104A. Any number of healthcare provider computers 104A and 104B, terminal care assessment modules 180, and/or claims processor computers 108 may be in communication with the service provider computer 106 as desired in various embodiments.

The service provider computer 106 may include any number of special purpose computers or other particular machines, application-specific circuits, microcontrollers, personal computers, minicomputers, mainframe computers, servers, networked computers, and/or other processor-driven devices. In certain example embodiments, the operations of the service provider computer 106 may be controlled by computer-executed or computer-implemented instructions that are executed by one or more processors associated with the service provider computer 106 to form a special-purpose computer or other particular machine that is operable to facilitate the receipt, routing, and/or processing of healthcare transactions. The one or more processors that control the operations of the service provider computer 106 may be incorporated into the service provider computer 106 and/or in communication with the service provider computer 106 via one or more suitable networks. In certain exemplary embodiments, the operations and/or control of the service provider computer 106 may be distributed amongst several processing components.

Similar to the healthcare provider computers 104A and 104B described above, the service provider computer 106 may include one or more processors 140, one or more memory devices 142, one or more input/output (“I/O”) interface(s) 144, and one or more network interface(s) 146. The one or more memory devices 142 may be any suitable memory devices, for example, caches, read only memory devices, random access memory devices, magnetic storage devices, removable memory devices, etc. The one or more memory devices 142 may store data, executable instructions, and/or various program modules utilized by the service provider 106, for example, data files 148, an operating system (“OS”) 150, the host module 154, a service provider module 156, and a database management system (“DBMS”) 152 to facilitate management of data files 148 and other data stored in the memory devices 142. The OS 150 may be, but is not limited to, Microsoft Windows®, Apple OSX™, Linux, Unix, or a mainframe operating system. The OS 150 may be a suitable software module that controls the general operation of the service provider computer 106 and/or that facilitates the execution of other software modules.

The service provider module 156 may be operable to perform one or more pre-edits or pre-analysis on a received healthcare transaction prior to routing or otherwise communicating the received healthcare transaction, such as a healthcare claim transaction, to a suitable claims processor computer 108 or an e-prescription transaction to a suitable pharmacy/healthcare provider computer 104A. Additionally, the service provider module 156 may be operable to perform one or more post-edits on an adjudicated reply or response that is received from a claims processor computer 108 for a healthcare transaction prior to routing the adjudicated response to one of the healthcare provider computers 104A and 104B. A wide variety of different pre-edits and/or post-edits may be performed as desired in various embodiments of the disclosure.

According to one exemplary embodiment, the data files 148 may store healthcare transaction records associated with communications received from various healthcare provider computers 104A and 104B, the terminal care assessment module 180, and/or various claims processor computers 108. The data files 148 may also store any number of suitable routing tables that facilitate determining the destination of communications received from a healthcare provider computer 104A and 104B, the terminal care assessment module 180, and/or the claims processor computer 108.

The exemplary data files 148 may also store records containing, for example, patient identification data, tables, schedules, or lists of patient identification data for patients receiving hospice care, ESRD or ESRD condition related care, and or terminal patient care (e.g., patient first name, patient last name, patient social security number or healthcare insurance claim number (HICN number), cardholder ID and/or person code for the patient), tables, schedules, or lists of medication/product/service identifiers for medications, products, or services provided to patients with ESRD or ESRD-related conditions or under terminal patient care for a terminal illness, or those patients in hospice care (e.g., the related NDC number for the medication, product, or service in the healthcare transaction), tables, schedules, or lists of diagnosis codes for patient diagnoses that relate to/are considered part of ESRD or ESRD-related conditions, or terminal patient care, tables, schedules, or lists of pharmacy identifiers for pharmacies receiving terminal care assessment services (e.g., pharmacy name or national provider identifier (NPI) number), tables, schedules, or lists of identifiers for claims processors receiving terminal care assessment services and/or that should not receive and pay for transactions for medications, products, or services related to care of ESRD or an ESRD-related condition or terminal patient care (e.g., banking identification number (BIN Number), BIN Number and processor control number (PCN) and/or BIN Number and Group ID).

The host module 154 may receive, process, and respond to requests from the client module 138 of one of the healthcare provider computers 104A and 104B, and may further receive, process, and respond to requests of the host module 172 of the claims processor computer 108. The service provider computer 106 may include additional program modules for performing other processing methods described herein. Those of ordinary skill in the art will appreciate that the service provider computer 106 may include alternate and/or additional components, hardware, or software without departing from exemplary embodiments disclosed herein.

With continued reference to the service provider computer 106, the one or more I/O interfaces 144 may facilitate communication between the service provider computer 106 and one or more input/output devices, for example, one or more user interface devices, such as a display, keypad, control panel, touch-screen display, remote control, microphone, etc. that facilitate user interaction with the service provider computer 106. The one or more network interfaces 146 may facilitate connection of the service provider computer 106 to one or more suitable networks, for example, the network 110 illustrated in FIG. 1. In this regard, the service provider computer 106 may communicate with other components of the system 100.

The terminal care assessment module 180 of FIG. 1 represents one or more modules that can evaluated a healthcare transaction or data from a healthcare transaction to determine if the transaction is for a medication, product, or service that is or potentially is related to patient care that may require a coverage determination for Medicare Part D Plans, such as ESRD or hospice care. The example terminal care assessment module 180 may include computer-executable instructions for receiving and processing healthcare transactions or healthcare transaction data from a service provider computer 106. The terminal care assessment module 180 may receive healthcare transactions or all or a portion of the data from healthcare transactions from the service provider computer 106. Upon receipt of the healthcare transaction data, the terminal care assessment module 180 may evaluate the data to determine if the healthcare transaction is for a medication, product, or service that is or is potentially related to patient care that may require a coverage determination for Medicare Part D Plans, such as ESRD or hospice care. Further, the terminal care assessment module 180 can evaluate the data from the healthcare transaction to determine if the patient identified in the healthcare transaction is a patient identified as receiving terminal care (e.g., care for ESRD, an ESRD condition, another terminal disease, or receiving care from a hospice). In addition, the terminal care assessment module 180 can determine if the healthcare transaction includes a diagnosis code and if that diagnosis code is for or associated with providing care for ESRD or ESRD-related conditions, terminal care, and/or hospice care to a patient. Further, the terminal care assessment module 180 can evaluate the healthcare transaction to determine if the transaction includes an override code that indicates the medication, product, or service requested in the healthcare transaction is not for the treatment of a disease or condition associated with ESRD or ESRD-related conditions, another terminal disease and/or hospice care. The terminal care assessment module 180 can communicate its analysis to the service provider computer 106 or it can, based on the analysis, determine whether to reject the healthcare transaction and return it to the healthcare provider computer 104 from which it was initially sent, or pass along the healthcare transaction to the claims processor computer 108 or the pharmacy/healthcare provider computer 104A depending on the type of healthcare transaction.

As desired, the terminal care assessment module 180 may include any number of special purpose computers or other particular machines, application-specific circuits, microcontrollers, personal computers, minicomputers, mainframe computers, servers, and the like. In certain exemplary embodiments, the operations of the terminal care assessment module 180 may be controlled by computer-executed or computer-implemented instructions that are executed by one or more processors associated with the terminal care assessment module 180 to form a special purpose computer or other particular machine that is operable to facilitate the receipt, processing, and/or storage of healthcare transactions and/or healthcare transaction data received from the service provider computer 106. The one or more processors that control the operations of the terminal care assessment module 180 may be incorporated into the terminal care assessment module 180 and/or in communication with the terminal care assessment module 180 via one or more suitable networks, such as network 110. In certain example embodiments, the operations and/or control of the terminal care assessment module 180 may be distributed amongst several processing components.

Similar to other components of the system 100, the terminal care assessment module 180 may include one or more processors, one or more memory devices, one or more I/O interfaces, and one or more network interfaces. The one or more memory devices may be any suitable memory devices, for example, caches, read only memory devices, random access memory devices, magnetic storage devices, removable memory devices. The one or more memory devices may store data, executable instructions, and/or various program modules utilized by the terminal care assessment module 180, for example, data files, an OS, a DBMS, and a host module. The data files may include any suitable information that is utilized by the terminal care assessment module 180 to receive, process, analyze, and/or store healthcare transaction data. The OS may be a suitable software module that controls the general operation of the particular terminal care assessment module 180. The OS may also facilitate the execution of other software modules by the one or more processors, for example, the DBMS and/or the host module. The OS may be, but is not limited to, Microsoft Windows®, Apple OSX™, Linux, Unix, or a mainframe operating system. The DBMS may be a suitable software module that facilitates access and management of one or more databases, such as database 182, that are utilized to store information that is received by or utilized by the terminal care assessment module 180 and/or the service provider computer 106. The host module may initiate, receive, process, analyze, store, and/or respond to requests, such as the receipt of healthcare transactions or healthcare transaction data from the host module 154 of the service provider computer 106. The terminal care assessment module 180 may include additional program modules as desired. Those of ordinary skill in the art will appreciate that the terminal care assessment module 180 may include alternate and/or additional components, hardware or software without departing from example embodiments disclosed herein.

The one or more I/O interfaces may facilitate communication between the terminal care assessment module 180 and one or more input/output devices, for example, one or more user interface devices, such as a display, keypad, control panel, touch-screen display, remote control, microphone, etc. that facilitate user interaction with the terminal care assessment module 180. The one or more network interfaces may facilitate connection of terminal care assessment module 180 to one or more suitable networks, for example, the network 110 illustrated in FIG. 1. In this regard, the terminal care assessment module 180 may receive healthcare transactions, healthcare transaction data, and/or other communications from the service provider computer 106. While FIG. 1 shows the terminal care assessment module 180 as being separate from the service provider computer 106, in certain example embodiments, the terminal care assessment module 180 is part of the service provider computer 106 and sending and receiving between the two are internal communications within the service provider computer 106.

The database(s) 182 may be operable to store information associated with various patients and/or various transactions involving terminal care assessment (e.g., patient care that may require a coverage determination for Medicare Part D Plans, such as ESRD or hospice care), including, but not limited to, patient identification data, tables, schedules, or lists of patient identification data for patients receiving hospice care, care related to ESRD or an ESRD-related condition, and/or terminal patient care for another terminal condition (e.g., patient first name, patient last name, patient social security number or HICN number, cardholder ID and/or person code for the patient), tables, schedules, or lists of medication/product/service identifiers for medications, products, or services provided under terminal patient care to terminally ill patients, under ESRD or ESRD-related condition care, or those patients in hospice care (e.g., the related NDC number for the medication, product, or service in the healthcare transaction), tables, schedules, or lists of diagnosis codes for patient diagnoses that relate to/are considered part of ESRD or ESRD-related condition care, hospice care, and/or terminal patient care, tables, schedules, or lists of pharmacy identifiers for pharmacies receiving terminal care assessment services (e.g., pharmacy name or NPI number), tables, schedules, or lists of identifiers for claims processors receiving terminal care assessment services and/or that should not receive and pay for transactions for medications, products, or services related to ESRD or ESRD-related condiction care, terminal patient care, and/or hospice care (e.g., BIN Number, BIN Number and PCN and/or BIN Number and Group ID). The patient and prescription medication data in the database 182 may then be accessed and evaluated by the terminal care assessment module 180 and/or the service provider computer 106.

With continued reference to FIG. 1, the claims processor computer 108 may be any suitable processor-driven device that facilitates receiving, processing, and/or fulfilling healthcare transactions, such as healthcare claim transactions, prescription claim or billing requests, healthcare order transactions, or e-prescription transactions (e.g., electronic prescription order transactions, e-scripts, or e-prescriptions) received from the service provider computer 106. For example, the claims processor computer 108 may be a processor-driven device associated with a pharmacy benefits manager (PBM), an insurer, a government payor, a Medicare Part D payor, or a claims clearinghouse. As desired, the claims processor computer 108 may include any number of special purpose computers or other particular machines, application-specific circuits, microcontrollers, personal computers, minicomputers, mainframe computers, servers, and the like.

In certain exemplary embodiments, the operations of the claims processor computer 108 may be controlled by computer-executed or computer-implemented instructions that are executed by one or more processors associated with the claims processor computer 108 to form a special-purpose computer or other particular machine that is operable to facilitate the receipt, processing, and/or fulfillment of healthcare transaction requests received from the service provider computer 106. The one or more processors that control the operations of the claims processor computer 108 may be incorporated into the claims processor computer 108 and/or in communication with the claims processor computer 108 via one or more suitable networks. In certain embodiments, the operations and/or control of the claims processor computer 108 may be distributed amongst several processing components.

Similar to other components of the system 100, the claims processor computer 108 may include one or more processors 158, one or more memory devices 160, one or more input/output (“I/O”) interfaces 162, and one or more network interfaces 164. The one or more memory devices 160 may be any suitable memory devices, for example, caches, read-only memory devices, random access memory devices, magnetic storage devices, removable memory devices. The one or more memory devices 160 may store data, executable instructions, and/or various program modules utilized by the claims processor computer 108, for example, data files 166, an operating system (“OS”) 168, a database management system (“DBMS”) 170, and a host module 172. The data files 166 may include any suitable information that is utilized by the claims processor computer 108 to process healthcare transactions, for example, patient profiles, patient insurance information, other information associated with a patient, information associated with a healthcare provider, etc. The operating system (OS) 168 may be a suitable software module that controls the general operation of the claims processor computer 108. The OS 168 may also facilitate the execution of other software modules by the one or more processors 158, for example, the DBMS 170 and/or the host module 172. The OS 168 may be, but is not limited to, Microsoft Windows®, Apple OSX™, Linux, Unix, or a mainframe operating system.

The DBMS 170 may be a suitable software module that facilitates access and management of one or more databases that are utilized to store information that is utilized by the claims processor computer 108 in various example embodiments of the disclosure. The host module 172 may initiate, receive, process, and/or respond to requests, such as healthcare transactions or claim requests, from the host module 154 of the service provider 106. The claims processor computer 108 may include additional program modules for performing other pre-processing or post-processing methods described herein. Those of ordinary skill in the art will appreciate that the claims processor computer 108 may include alternate and/or additional components, hardware or software without departing from the example embodiments described herein.

The one or more I/O interfaces 162 may facilitate communication between the claims processor computer 108 and one or more input/output devices, for example, one or more user interface devices, such as a display, keypad, control panel, touch-screen display, remote control, microphone, etc. that facilitate user interaction with the claims processor computer 108. The one or more network interfaces 164 may facilitate connection of the claims processor computer 108 to one or more suitable networks, for example, the network 110. In this regard, the claims processor computer 108 may receive healthcare transactions and/or other communications from the service provider computer 106 and the claims processor computer 108 may communicate information associated with processing the healthcare transactions to the service provider computer 106.

The network 110 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 110 may also allow for real-time, off-line, and/or batch transactions to be transmitted between or among the healthcare provider computers 104A and 104B, the service provider computer 106, terminal care assessment module 180, and/or the claims processor computer 108. Due to network connectivity, various methodologies, as described herein may be practiced in the context of distributed computing environments. Although the service provider computer 106 is shown for simplicity as being in communication with the healthcare provider computers 104A and 104B, the terminal care assessment module 180, or the claims processor computer 108 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices in accordance with an example embodiment. For example, the service provider computer 106 may form the basis of network 110 that interconnects one or more of the healthcare provider computers 104A and 104B, the terminal care assessment module 180, and the claims processor computer 108.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one exemplary embodiment, the service provider computer 106 (or other computer) may be implemented as a specialized processing machine that includes hardware and/or software for performing the methods described herein. In addition, at least a portion of the processor and/or processing capabilities of the service provider computer 106 may be implemented as part of the claims processor computer 108 or the healthcare provider computer 104. In addition, at least a portion of the processor and/or processing capabilities of the healthcare provider computer 104, and/or the claims processor computer 108 may be implemented as part of the service provider computer 106. Accordingly, the exemplary embodiments described herein should not be construed as being limited to any particular operating environment, system architecture, or device configuration.

Operational Overview

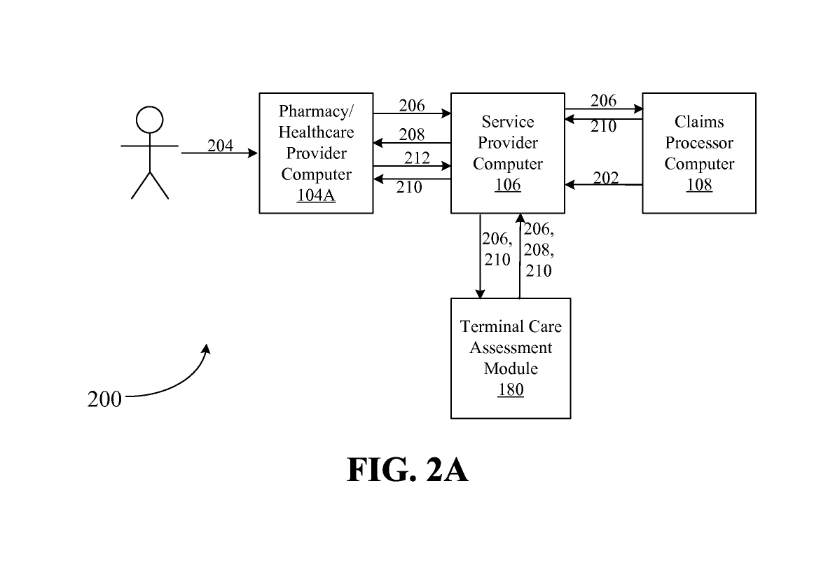

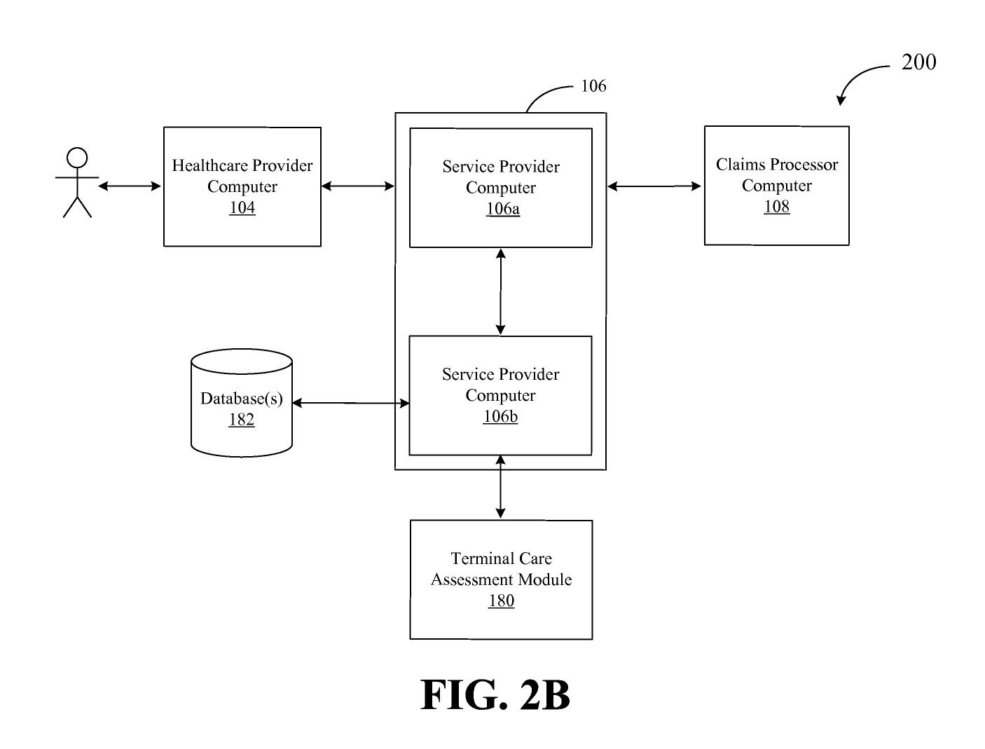

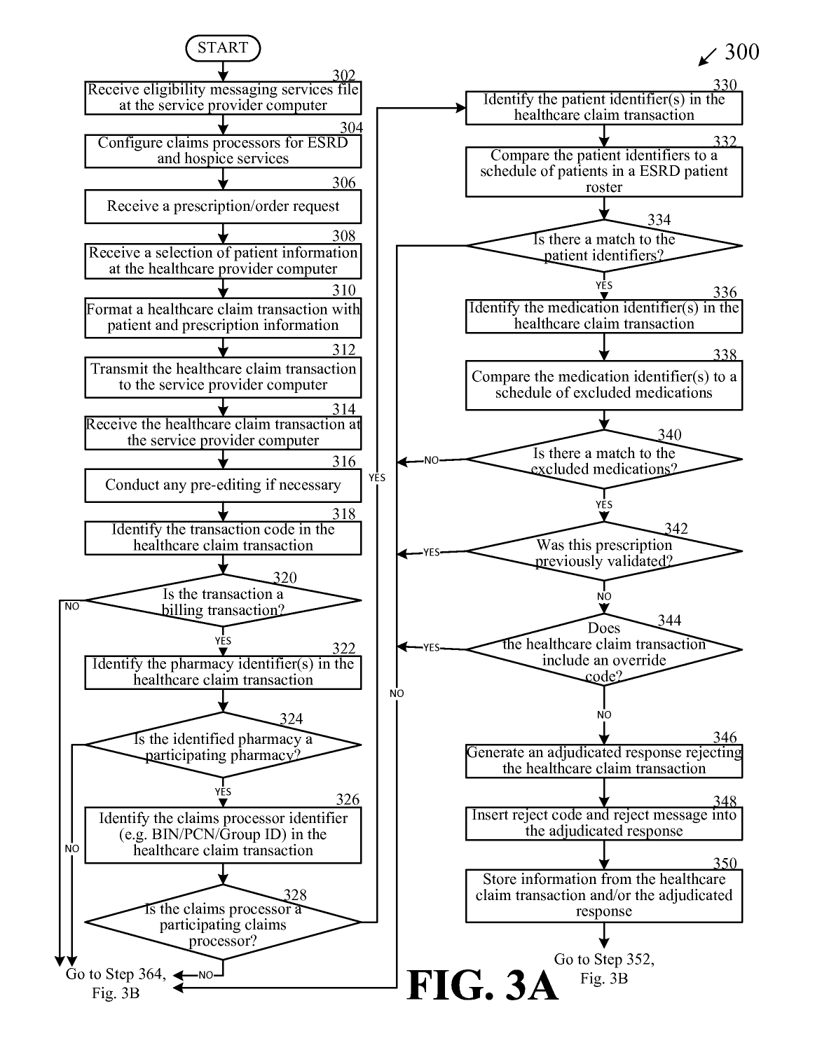

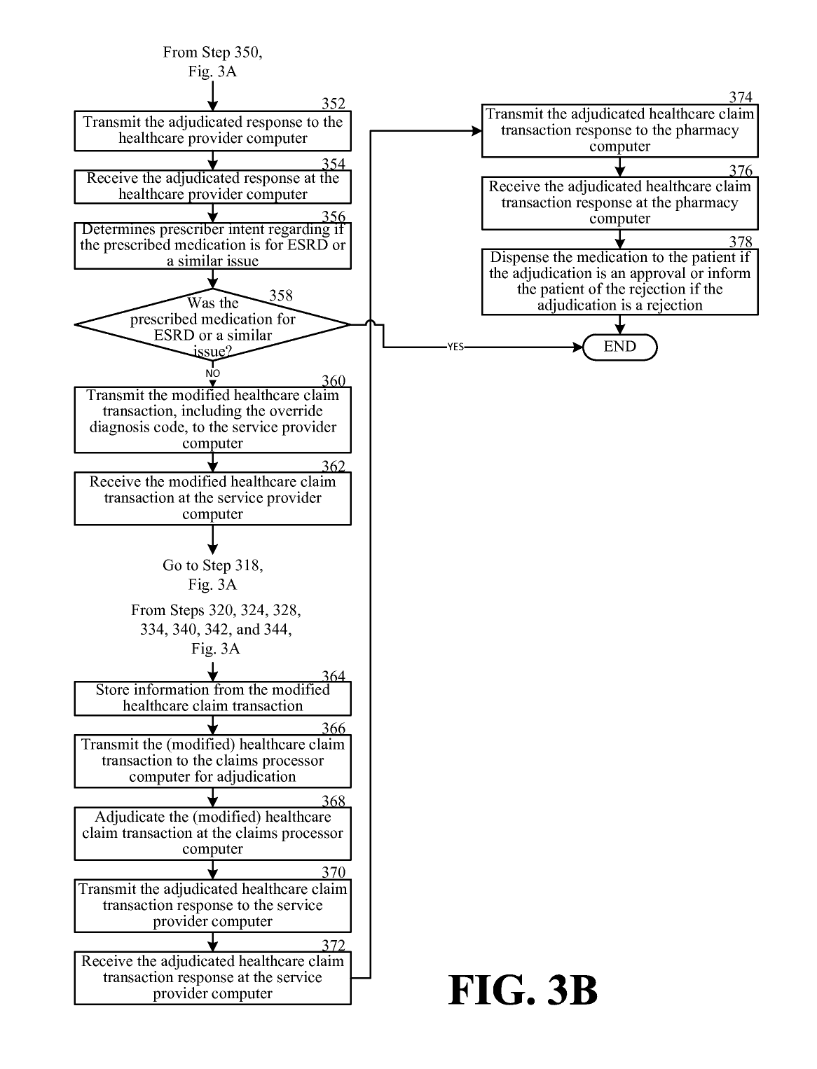

FIG. 2A is a diagram of one example data flow 200 for evaluating claims to determine if they are for medications, products, or services related to patient care that may require a coverage determination for Medicare Part D Plans, such as ESRD or hospice care as part of the processing of the healthcare transaction through a service provider computer, such as through the service provider computer 106 illustrated in FIG. 1. FIGS. 3A-B are flow charts of an example method 300 for evaluating claims to determine if they are for medications, products, or services related to patient care that may require a coverage determination for Medicare Part D Plans, such as ESRD or hospice care as part of the processing of a healthcare transaction (such as a predetermination of benefits transaction, a healthcare claim transaction, prescription claim or billing request, healthcare order transaction, or e-prescription transaction (e.g., electronic prescription order transaction, e-script, or e-prescription)) for that patient through a service provider computer, in accordance with one exemplary embodiment. All or a portion of the steps in the exemplary method 300, described below, may be performed by a suitable service provider computer 106 or terminal care assessment module 180. The exemplary method 300 will be described with reference to a pharmacy as the healthcare provider (and accordingly a pharmacy computer as the pharmacy/healthcare provider computer 104A); however, this is only for purposes of example as other healthcare providers could be substituted for, and should each be individually read as being a part of each of these methods. As such, where the discussion of the methods below and the drawings state a pharmacy, any other healthcare provider could be substituted, such as a physician, hospital, physician's office, clinic, or healthcare center.

In addition, the exemplary method 300 will be described with reference to a healthcare claim transaction (e.g., prescription claim request, prescription billing request, or healthcare order transaction); however, this also is only for purposes of example as other healthcare transactions, which may include, for example, a predetermination of benefits transaction, the healthcare claim transaction, prescription claim or billing request, healthcare order transaction, or e-prescription transaction (e.g., electronic prescription order transaction, e-script, or e-prescription) could be substituted for the healthcare claim transaction and each form of healthcare transaction should each individually be read as being used in the method described below.

Referring now to FIGS. 1, 2A, and 3A-B, the exemplary method 300 begins at the START step and proceeds to step 302, where the service provider computer 106 can receive an eligibility messaging services file 202 from, for example, one or more claims processor computers 108 or the insurance provider, pharmacy benefits manager, Medicare Part D provider or other entity represented by the claims processor associated with the claims processor computer 108. In one example embodiment, the eligibility messaging services file 202 can include a table, list, or schedule of patients and/or patient identifiers (e.g., patient first name, patient last name, patient date of birth, patient gender, patient address, patient social security number, patient HICN, insurance cardholder name, and/or insurance person code) that identifies patients receiving ESRD or ESRD-related condition care, care for another terminal condition, and/or hospice care. In addition, the eligibility messaging services file 202 can include a table, list, or schedule of medications, products, and or services that are typically provided only by hospice care, for ESRD, for ESRD-related condictions, and/or for care of another terminal condition for a patient. In one example embodiment, the medications for ESRD, ESRD-related conditions, another terminal condition for the patient, and hospice care include, but are not limited to antiemetic medications, anti-infective medications (including antibacterial and antifungal medications), antipruritic medications (including antibacterial and antifungal medications), anxiolytic medications, excess fluid management medications, fluid and electrolyte management and volume expander medications (including intravenous medications/fluids used to treat fluid and electrolyte needs), and pain management medications (including pain management overdoes treatment medications). While the example embodiment shows one file 202 being received, in certain example embodiments, multiple files can be received by the service provider computer from multiple claims processor computers 106 or those represented by the claims processor computer. The eligibility messaging services files 202 can be received electronically or via paper and entered into an electronic file in the database 182 or data files 148. Further, while the example embodiment shows the eligibility messaging services files 202 being received once, this is for example only, as these files 202 can be received and updated daily, weekly, monthly, quarterly, annually, or any other constant or variable time period.

In step 304, the service provider computer 106 can configure the evaluation rules for the healthcare transactions to evaluate for patient care that may require a coverage determination for Medicare Part D Plans, such as ESRD or hospice care, for the claims processor computers 108. For example, the service provider computer 106 can be configured to determine, for each claims processor computer 108, whether diagnosis code information should be included in the healthcare transaction before transmitting the healthcare transaction to the claims processor computer 108, the medication identifiers for the medications that are excluded (e.g., considered to be for ESRD, ESRD-related conditions, another terminal condition for a patient, and/or hospice care and for which the claims processor will not generally pay any portion of the claim in the healthcare transaction, and the messages for the particular claims processor computer 108 that will be included in rejections generated by the service provider computer 106 and transmitted back to the healthcare provider computer 104. In certain example embodiments, the configuration information for the claims processor computers 108 can be stored in the database 182 and/or the data files 148.

In step 306, a prescription/order request 204 is received. In one example embodiment, the prescription/order request 204 is received by a pharmacist at a pharmacy. The prescription/order request 204 may be received from a patient, another healthcare provider prescribing a medication or service (e.g., physician, clinic, physician's office, hospital, etc.), by phone, via the Internet, via an electronic prescription or by way of an electronic system order. For example, the prescription 204 may be received by the patient from a prescriber of the medication, such as a doctor, dentist, nurse, physician's assistant, or any other person authorized to prescribe medications, products, and/or services for a patient. The patient may go to the location of the pharmacy and physically hand the prescription request 204 to the pharmacist or make a request via a web portal communicably coupled to the healthcare provider computer 104 or an IVR communicably coupled or otherwise providing order data to the healthcare provider computer 104. The pharmacist determines the patient's name and accesses the pharmacy/healthcare provider computer 104A, which receives a selection of patient information from the pharmacist via the I/O interface 128A in step 308. For example, the pharmacist accesses the pharmacy/healthcare provider computer 104A and accesses a database of patient information, which may be stored in memory 126A or in another database either local or remote from the pharmacy/healthcare provider computer 104A. The pharmacist can then select the name or other patient identification information in the patient information database that matches the name or other identification information of the patient.

In step 310, a first healthcare claim transaction 206 is generated and/or formatted at the pharmacy/healthcare provider computer 104A. In certain exemplary embodiments, the pharmacy/healthcare provider computer 104A formats the first healthcare claim transaction 206 with patient information (e.g., patient identifiers), Payor ID/routing information (e.g., claims processor identifiers), and medication information (e.g., medication identifiers). The information can be input into the first healthcare claim transaction 206 by the pharmacist via the I/O interface 128A or automatically retrieved and entered by the pharmacy/healthcare provider computer 104A and, in certain situations, can be based at least in part on historical transaction information for the patient in the data files 132A or a database communicably coupled to the pharmacy/healthcare provider computer 104A. According to one example embodiment, the first healthcare claim transaction 206 may be formatted in accordance with a version of the National Council for Prescription Drug Programs (NCPDP) Telecommunication Standard, although other standards, such as American National Standards Institute (ANSI) ASC X-12 Standard, Health Level 7 (HL7) Standard, or NCPDP Script Standard may be utilized as well.

As discussed above, the first healthcare claim transaction 206 may include a BIN Number, a BIN Number and PCN, and/or a BIN Number and Group ID for identifying a particular claims processor computer (e.g., PBM, payor, healthcare insurance company, Medicare or other government healthcare insurance payor, Medicare Part D provider, etc.), such as the claims processor computer 108, as a destination for the first healthcare claim transaction 206. In addition, the first healthcare claim transaction 206 may also include information relating to the patient, payor, prescriber, healthcare provider, and/or the requested medication. As an example, the first healthcare claim transaction 206 may include one or more of the following information:

Payor ID/Routing Information
BIN Number, BIN Number and PCN and/or BIN Number and Group ID, that designates a destination payor of the healthcare claim transaction 206

Patient Information
Name (e.g. Patient Last Name, Patient First Name, etc.)
Date of Birth of Patient
Age of Patient
Gender of Patient
Patient Address (e.g. Street Address, City, State, Zip/Postal Code, etc.)
Patient Contact Information (e.g. Patient Telephone Number, Email Address, etc.)
Patient Health Condition Information
Patient ID or other identifier (e.g., Health Insurance Claim Number (HICN), Social Security Number, etc.)

Insurance/Coverage Information
Cardholder Name (e.g. Cardholder First Name, Cardholder Last Name)
Cardholder ID and/or other identifier (e.g. Person Code)
Group ID and/or Group Information

Prescriber Information
Primary Care Provider ID or other identifier (e.g. National Provider Identifier (NPI) code)
Primary Care Provider Name (e.g. Last Name, First Name)
Prescriber ID or other identifier (e.g. NPI code, Drug Enforcement Agency (DEA) number)
Prescriber Name (e.g. Last Name, First Name)
Prescriber Contact Information (e.g. Telephone Number, Email Address, Fax Number, etc.)
Pharmacy or other Healthcare Provider Information (e.g. Store Name, Store Address, Chain Identifier, etc.)
Pharmacy or other Healthcare Provider ID (e.g. NPI code)

Claim Information
Drug, service, or product information (e.g. National Drug Code (NDC) code, RxNorm code, etc.)
Prescription/Service Reference Number
Date Prescription Written
Quantity Dispensed
Days' Supply
Diagnosis/Condition (e.g., Diagnosis Code (e.g., International Statistical Classification of Diseases and Related Health Problems (ICD) Diagnosis Code)
Pricing information for the drug/service/product (e.g. Network Price, Usual & Customary price)
Number of Refills Authorized
One or more NCPDP Message Fields
One or more Drug Utilization (DUR) Codes
Date of Service.

The first healthcare claim transaction 206 can be used to determine if the claims processor associated with the claims processor computer 108 approves or rejects payment coverage for medication, products, or services being requested in the first healthcare claim transaction 206 and, if approved, the amount the claims processor will cover (or pay) for the medication, products, or services being requested and how much the patient co-pay amount will be.

The pharmacy/healthcare provider computer 104A can transmit the first healthcare claim transaction 206 to the service provider computer 106 in step 312. In step 314, the service provider computer 106 receives the first healthcare claim transaction 206. For example, the first healthcare claim transaction 206 can be transmitted by the pharmacy/healthcare provider computer 104A to the service provider computer 106 through the network 110. The service provider computer 106 conducts any pre-editing, if necessary, on the first healthcare claim transaction 206 in step 314. The pre-edits may include verifying, adding, and/or editing information included in the first healthcare claim transaction 206 prior to it being communicated to a claims processor computer 108. For example, the service provider computer 106 can parse the first healthcare claim transaction 206 to determine/edit the financial fields, the service code, the quantity dispensed, and or the patient age.

In step 318, the transaction code in the first healthcare claim transaction 206 can be identified. The transaction code can be an alphanumeric code that identifies the type of transaction and can be included in an agreed-upon field of the first healthcare claim transaction 206. In one example embodiment, the transaction code can be identified by the terminal care assessment module 180 or another portion of the service provider computer 106 based on a review of the data in the first healthcare claim transaction 206. In step 320, an inquiry is conducted to determine if the transaction code identifies the transaction as a billing transaction. In one example embodiment, the terminal care assessment module 180 or another portion of the service provider computer 106 can determine if the transaction code identifies the transaction 206 as a billing transaction. For example, the terminal care assessment module 180 can compare the identified transaction code to a table, schedule, or list of transaction codes to determine if the identified transaction code matches a transaction code for a billing transaction. If the identified transaction code does not identify the transaction 206 as a billing transaction, the NO branch can be followed to the END step or to step 364 of FIG. 3B if the identified transaction type is one that is to be transmitted to the claims processor computer. On the other hand, if the identified transaction code is for a billing transaction, the YES branch is followed to step 322.

In step 322, the one or more pharmacy identifiers in the first healthcare claim transaction 206 can be identified. For example, the pharmacy identifier can be the NPI code for the pharmacy. Additional pharmacy identifiers can be the pharmacy name, pharmacy address, pharmacy contact information, and the chain identifier and chain name for the pharmacy that sent the first healthcare claim transaction 206. In one example embodiment, the one or more pharmacy identifiers can be identified by the terminal care assessment module 180 or another portion of the service provider computer 106 based on a review of the data in the first healthcare claim transaction 206. In step 324, an inquiry is conducted to determine if the pharmacy identifier identifies the pharmacy as one for which terminal care and hospice care assessment of healthcare transactions is being completed. For example, the pharmacy or the chain to which the pharmacy belongs, can sign up to have the transactions evaluated for ESRD, terminal care, and hospice care potential to reduce the possibility that it will subsequently be determined that the claims processor identified in the first healthcare claim transaction 206 should not have paid for the medication, product, or service requested therein because it was for care of ESRD or an ESRD-related condition, care for another terminal condition, or the patient was receiving care in a hospice. In one example embodiment, the terminal care assessment module 180 or another portion of the service provider computer 106 can determine if the pharmacy identifier identifies the transmitting pharmacy as one that is receiving ESRD, terminal care, and hospice care assessment services. For example, the terminal care assessment module 180 can compare the identified pharmacy identifier to a table, schedule, or list of pharmacy identifiers to determine if the identified pharmacy identifier matches a stored pharmacy identifier representing a pharmacy receiving ESRD, terminal care, and hospice care assessment of healthcare transactions. If the identified pharmacy identifier does not identify a pharmacy receiving ESRD, terminal care, and hospice care assessment of healthcare transactions, the NO branch can be followed to step 364 of FIG. 3B. Otherwise, the YES branch is followed to step 326.

In step 326, the one or more claims processor/payor identifiers in the healthcare claim transaction can be identified. For example, the claims processor identifier can be the BIN Number, BIN Number and PCN, or BIN Number and Group ID. In one example embodiment, the claims processor identifier can be identified by the terminal care assessment module 180 or another portion of the service provider computer 106 based on a review of the data in the first healthcare claim transaction 206. In step 328, an inquiry is conducted to determine if the claims processor identifier identifies the claims processor (e.g., PBM, payor, healthcare insurance company, Medicare or other government healthcare insurance payor, Medicare Part D provider, etc.) as one for which ESRD, terminal care, and hospice care assessment of healthcare transactions is being completed. For example, the claims processor can sign up to have the transactions evaluated for ESRD and ESRD-related condition care, another terminal condition care, and hospice care potential to reduce the possibility that it will subsequently be determined that the claims processor identified in the first healthcare claim transaction 206 should not have paid for the medication, product, or service requested therein because it was for ESRD or ESRD-related condition care, care for another terminal condition for the patient or the patient was receiving care in a hospice. In one example embodiment, the terminal care assessment module 180 or another portion of the service provider computer 106 can determine if the claims processor identifier identifies the claims processor as one that is receiving ESRD, terminal care, and hospice care assessment services. For example, the terminal care assessment module 180 can compare the identified claims processor identifier to a table, schedule, or list of stored claims processor identifiers to determine if the identified claims processor identifier matches a stored claims processor identifier representing a claims processor receiving ESRD, terminal care, and hospice assessment of healthcare transactions. If the identified claims processor identifier does not identify a claims processor receiving ESRD, terminal care, and hospice care assessment of healthcare transactions, the NO branch can be followed to step 364 of FIG. 3B. Otherwise, the YES branch is followed to step 330.

In step 330, the one or more patient identifiers in the healthcare claim transaction can be identified. For example, the patient identifiers can be the Cardholder Name (e.g., cardholder first name and last name (which can be different from the patient's first and last name) on the patient's insurance card) and Cardholder ID (e.g., person code on the patient's insurance card). In addition, or in the alternative, the patient identifiers can be one or more of the patient first name, patient last name, patient gender, patient date of birth, patient address, patient contact information (e.g., phone number or email address), patient social security number, and/or patient HICN. In one example embodiment, the one or more patient identifiers can be identified by the terminal care assessment module 180 or another portion of the service provider computer 106 based on a review of the data in the first healthcare claim transaction 206. In step 332, the identified one or more patient identifiers can be compared to a table, schedule, or list of patient identifiers for patients receiving patient care that may require a coverage determination for Medicare Part D Plans, such as ESRD, ESRD-related conditions, another terminal condition, or hospice care. In certain example embodiments, the list of patient identifiers for patients receiving patient care that may require a coverage determination for Medicare Part D Plans, such as ESRD, ESRD-related condition care, care for another terminal condition, or hospice care can be based on the eligibility messaging services file 202 received from the claims processor, as discussed in step 302. In one example embodiment, the comparison can be made by the terminal care assessment module 180 or another portion of the service provider computer 106.

In step 334, an inquiry is conducted to determine if the identified one or more patient identifiers matches one or more of the patient identifiers in the table, schedule, or list of identifiers for patients receiving patient care that may require a coverage determination for Medicare Part D Plans, such as ESRD, ESRD-related condition care, care for another terminal condition, or hospice care. In one example embodiment, the terminal care assessment module 180 or another portion of the service provider computer 106 can determine if a match exists. If the identified one or more patient identifiers does not match a patient identifier for a patient receiving patient care that may require a coverage determination for Medicare Part D Plans, such as ESRD, ESRD-related condition care, care for another terminal condition, or hospice care, the NO branch can be followed to step 364 of FIG. 3B. Otherwise, the YES branch is followed to step 336.

In step 336, the identifier for the medication, product, or service being requested in the first healthcare claim transaction 206 (hereinafter, the medication identifier) can be identified. For example, the medication identifier can be the NDC code or RxNorm number for the medication, product, or service. In addition, or in the alternative, the medication identifier can be the name of the medication, product, or service. In one example embodiment, the medication identifier can be identified by the terminal care assessment module 180 or another portion of the service provider computer 106 based on a review of the data in the first healthcare claim transaction 206. In step 338, the identified medication identifier can be compared to a table, schedule, or list of medication identifiers for excluded medications (e.g., medications, products, or services for which the claims processor will not pay any portion of the cost because they are medications typically provided to patients for ESRD or ESRD-related condition care, care for another terminal condition and/or hospice care. In certain example embodiments, the list of medication identifiers for excluded medications can be based on the medication identifiers received in the eligibility messaging services file 202 received from the claims processor, as discussed in step 302. In one example embodiment, the comparison can be made by the terminal care assessment module 180 or another portion of the service provider computer 106.

In step 340, an inquiry is conducted to determine if the identified medication identifier matches one or more of the medication identifiers in the table, schedule, or list of medication identifiers for excluded medications. In one example embodiment, the terminal care assessment module 180 or another portion of the service provider computer 106 can determine if a match exists. If the identified medication identifier does not match a medication identifier for an excluded medication, the NO branch can be followed to step 364 of FIG. 3B. Otherwise, the YES branch is followed to step 342.

In step 342, an inquiry is conducted to determine if the prescription identified in the first healthcare claim transaction 206 was previously validated. In one example embodiment, the determination can be made by the terminal care assessment module 180 or another portion of the service provider computer 106. For example, the terminal care assessment module 180 can compare the prescription number for the first healthcare claim transaction 206 to a table, schedule, or list of prescription numbers (e.g., in the database 182 or data files 148) for healthcare transactions that have been previously validated (e.g., the requested medication, product, or service, for the identified patient in the transaction 206 has previously been verified to not be for patient care that may require a coverage determination for Medicare Part D Plans, such as ESRD, ESRD-related condition care, care for another terminal condition, or hospice care) to determine if a match exists. If a match does exist, the YES branch can be followed to step 364 of FIG. 3B. On the other hand, if a match does not exist, the NO branch can be followed to step 344.

In step 344, an inquiry is conducted to determine if the first healthcare claim transaction 206 includes an override code. The determination can be made by the terminal care assessment module 180 or another portion of the service provider computer 106. For example, the terminal care assessment module 180 can parse the first healthcare claim transaction 206 and review the override code field in the transaction 206 to determine if it includes an override code and if that override code is one that identifies the medication, product, or service requested in the transaction 206 as not being for patient care that may require a coverage determination for Medicare Part D Plans, such as ESRD, ESRD-related condition care, care for another terminal condition, or hospice care. In an alternative embodiment, the override code can be a diagnosis code identifying a diagnosis for the ailment currently affecting the patient or a verification that the diagnosis is not related to patient care that may require a coverage determination for Medicare Part D Plans, such as ESRD, ESRD-related condition care, care for another terminal condition, or hospice care, and can be found in the diagnosis code field of the first healthcare claim transaction 206. In this alternative embodiment, the diagnosis code can be compared to a table, schedule, or listing of diagnosis codes that are for an ailment that is not related to patient care that may require a coverage determination for Medicare Part D Plans, such as ESRD, ESRD-related condition care, care for another terminal condition, or hospice care. Alternatively, the table of diagnosis codes can be for ailments related to patient care that may require a coverage determination for Medicare Part D Plans, such as ESRD, ESRD-related condition care, care for another terminal condition, or hospice care, in which case the YES and NO branches discussed below would be reversed. In certain example embodiments, the terminal care override code could have been previously provided to the pharmacy/healthcare provider computer 104A by the service provider computer 106. If a determination is made that the transaction 206 includes a proper override code (the override code matches one or more override codes that identifies the medication, product, or service requested in the transaction 206 as not being for patient care that may require a coverage determination for Medicare Part D Plans, such as ESRD, ESRD-related condition care, care for another terminal condition, or hospice care, or the override code matches a diagnosis code for the patient that identifies a diagnosis that is not for patient care that may require a coverage determination for Medicare Part D Plans, such as ESRD, ESRD-related condition care, care for another terminal condition, or hospice care), then the YES branch is followed to step 364 of FIG. 3B. Otherwise, the NO branch is followed to step 346.

In step 346, the first healthcare claim transaction 206 is rejected. In one example embodiment, the rejection 208 of the first healthcare claim transaction 206 can be generated by the terminal care assessment module 180 or another portion of the service provider computer 106 without sending the transaction 206 to a claims processor computer 108 for adjudication. In step 348, the terminal care assessment module 180 or another portion of the service provider computer 106 can insert the reject code, and optionally the reject message, into the adjudicated response to the first healthcare claim transaction 208. For example, the reject code can include code “A4 (this product may be covered under the Medicare-B bundled payment to an ESRD dialysis facility.” In addition, the rejection message could state, for example, “ESRD patient and Rx may be ESRD related. Document Rx is ‘Not ESRD related or Rx, place ‘NR2ESRD’ in diagnosis code field and resubmit. If ‘ESRD related’ direct patient to dialysis facility for medication or process as ‘cash transaction’.” The adjudicated response to the first healthcare claim transaction 208 may also include an override code that can be used by the pharmacy when submitting a modified healthcare claim transaction 212.

In step 350, all or a portion of the information from the first healthcare claim transaction 206 and/or the adjudicated response to the first healthcare claim transaction 208 can be stored for subsequent evaluation. For example, the information can be stored in the database 182 and/or the data files 148 and can include, but is not limited to, the prescription number, the medication identifier, the one or more patient identifiers, and the pharmacy identifier. In one example embodiment, the information from the first healthcare claim transaction 206 and/or the adjudicated response 208 can be stored by the terminal care assessment module 180 or another portion of the service provider computer 106. In step 352, the adjudicated response to the first healthcare claim transaction 208 can be transmitted to the pharmacy/healthcare provider computer 104A. For example, the service provider computer 106 can transmit the adjudicated response 208 via the network 110 to the pharmacy/healthcare provider computer 104A.

The pharmacy/healthcare provider computer 104A can receive the adjudicated response to the first healthcare claim transaction 208, which includes the rejection by the service provider computer 106, in step 354. In step 356, the pharmacist or another pharmacy employee can determine the prescriber's intent as to whether the requested medication, product, or service is for terminal patient care (e.g., ESRD care), hospice care, or a similar issue. For example, the pharmacist can call the prescriber to determine why the medication, product, or service is being prescribed or can ask the patient why it is prescribed. In step 358, an inquiry is conducted to determine if the requested medication, product, or service is for patient care that may require a coverage determination for Medicare Part D Plans, such as ESRD, ESRD-related condition care, care for another terminal condition, or hospice care. If the pharmacist determines that the requested medication, product, or service is for patient care that may require a coverage determination for Medicare Part D Plans, such as ESRD, ESRD-related condition care, care for another terminal condition, or hospice care, the YES branch can be followed to the END step. Otherwise, the NO branch can be followed to step 360.

In step 360, the pharmacist can generate a modified healthcare claim transaction 212 and the pharmacy/healthcare provider computer 104A can transmit the modified healthcare claim transaction 212 to the service provider computer 106 via, for example, the network 110. For example, the modified healthcare claim transaction 212 can include the override diagnosis code that was previously provided to the pharmacy/healthcare provider computer 104A in the adjudicated response to the first healthcare claim transaction 208. In this example, the override diagnosis code can be placed into an agreed upon field of the modified healthcare claim transaction 212, such as the diagnosis code field. Further, in certain example embodiments, the prescription number, medication identifier, pharmacy identifier, claims processor identifier, and one or more patient identifiers in the modified healthcare claim transaction 212 and the first healthcare claim transaction can be the same. In step 362, the service provider computer 106 receives the modified healthcare claim transaction 212 from the pharmacy/healthcare provider computer 104A. The process then returns to step 318, where steps 318-362 may be repeated for the modified healthcare claim transaction 212 in a manner substantially the same as that discussed above for the first healthcare claim transaction 206, as one of ordinary skill in the art will recognize. For example, in such a situation, in step 344, the terminal care assessment module 180 may determine that the modified healthcare claim transaction 212 includes an override diagnosis code in the diagnosis code or override field of the modified healthcare claim transaction 212 and may further determine that the diagnosis code matches an override diagnosis code or is for a diagnosis for the patient that is not related to patient care that may require a coverage determination for Medicare Part D Plans, such as ESRD, ESRD-related condition care, care for another terminal condition, or hospice care. Based on that determination, the process may proceed to step 364 of FIG. 3B.

In step 364, information from the first healthcare claim transaction 206 or the modified healthcare claim transaction 212 can be stored in, for example, the database 182 or the data files 148. For example, the terminal care assessment module 180 or another portion of the service provider computer 106 can store the prescription number, the medication identifier, the one or more patient identifiers, the pharmacy identifier, and the claims processor identifier.

The service provider computer 106 can transmit the first healthcare claim transaction 206 or the modified healthcare claim transaction 212 to the claims processor computer 108 in step 366. For example, the first healthcare claim transaction 206 or modified healthcare claim transaction 212 can be transmitted from the service provider computer 106 to the claims processor computer 108 via the network 110. The claims processor computer 108 receives and adjudicates the first healthcare claim transaction 206 or the modified healthcare claim transaction 212 in step 368 to determine if the patient has coverage, to determine to what extent the patient's coverage covers the requested medication identified in the transaction 206, 212, and to generate an adjudication 210 as to whether the transaction 206, 212 is approved or rejected. Example adjudications 210 can include, but are not limited to, accepted, approved, paid, captured, denied, and denied with request for additional information and resubmission. In certain exemplary embodiments, the adjudication can be input into a field of the healthcare claim transaction 206, 212 that is recognized by the service provider computer 106 and/or the pharmacy/healthcare provider computer 104A. Typically, if the transaction 206, 212 is approved, the adjudicated response 210 provides the amount of the cost of the medication, product, or service that will be covered by the claims processor associated with the claims processor computer 108 and the patient co-pay amount and if rejected, the adjudicated response 210 provides the reason for the rejection (e.g., for example, patient not covered, Cardholder ID submitted in the transaction is inactive, prior authorization required, medication not covered, etc.), such as in the form of a reject code. In step 370, the claims processor computer 108 transmits the adjudicated healthcare claim transaction response 210 to the service provider computer 106 via, for example, the network 110.

The service provider computer 106 receives the adjudicated healthcare claim transaction response 210 from the claims processor computer 108 in step 372. In step 374, the service provider computer 106 can transmit the adjudicated healthcare claim transaction response 210 to the pharmacy/healthcare provider computer 104A via, for example, the network 110. The pharmacy/healthcare provider computer 104A receives the adjudicated healthcare claim transaction response 210 from the service provider computer 106 in step 376. In step 378, the pharmacy, such as a pharmacist or other pharmacy employee can dispense the medication to the patient if the response status in the adjudicated response 210 is an approval or can inform the patient of the rejection if the response status is a rejection. The process then continues to the END step.

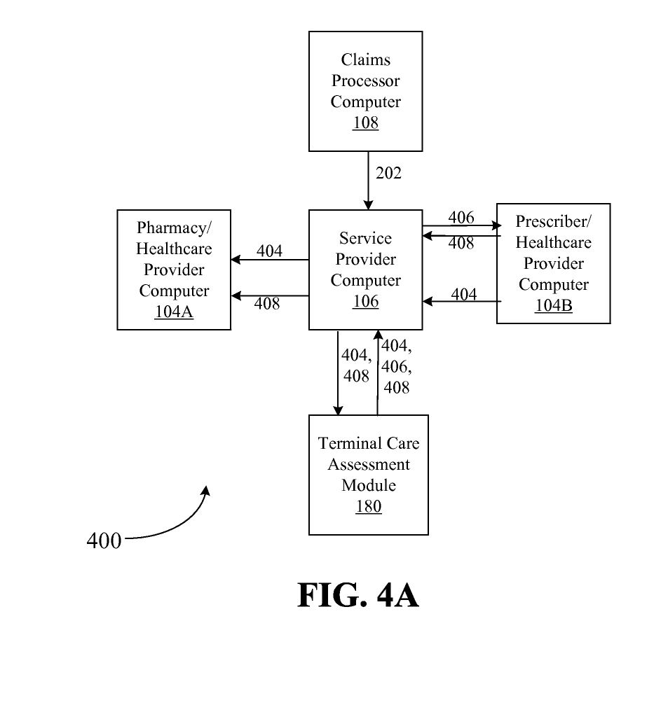

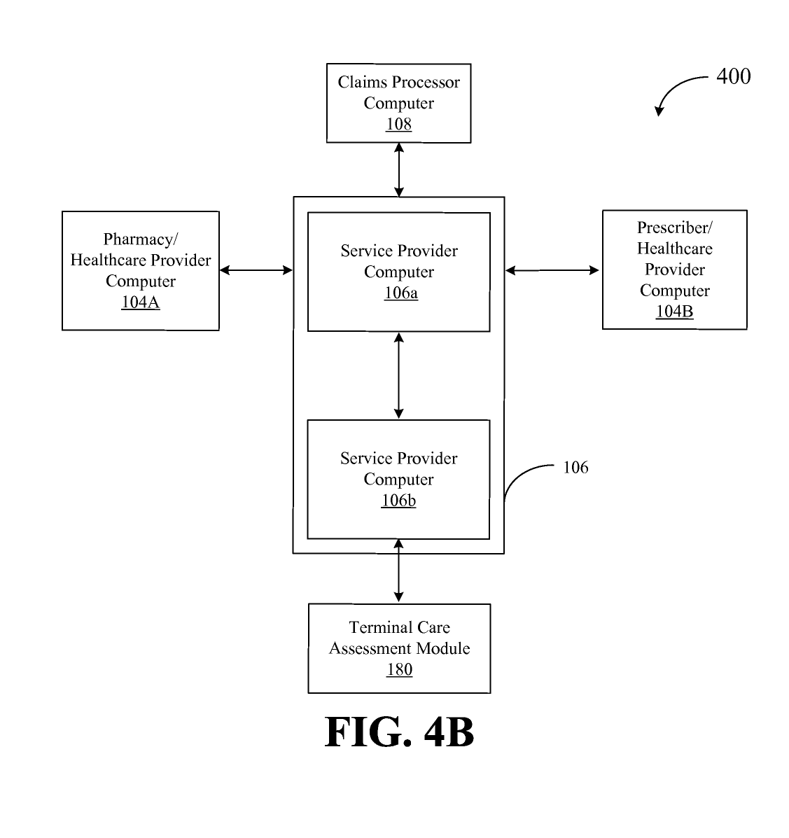

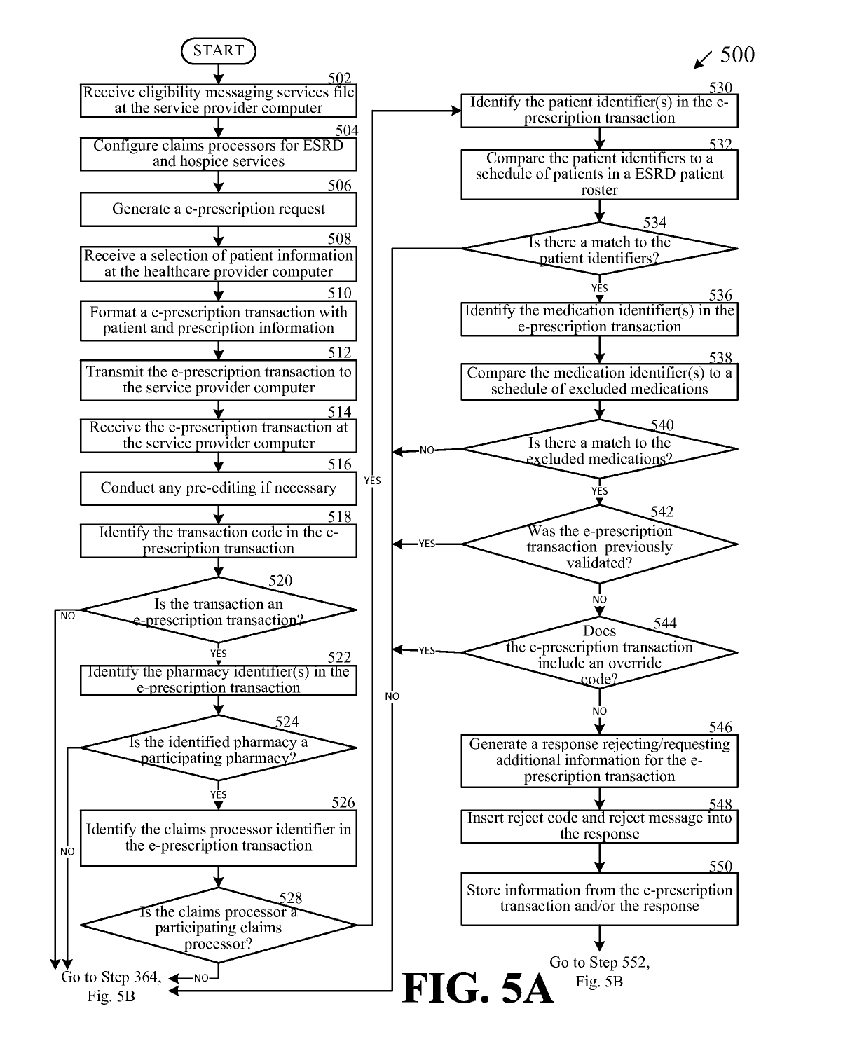

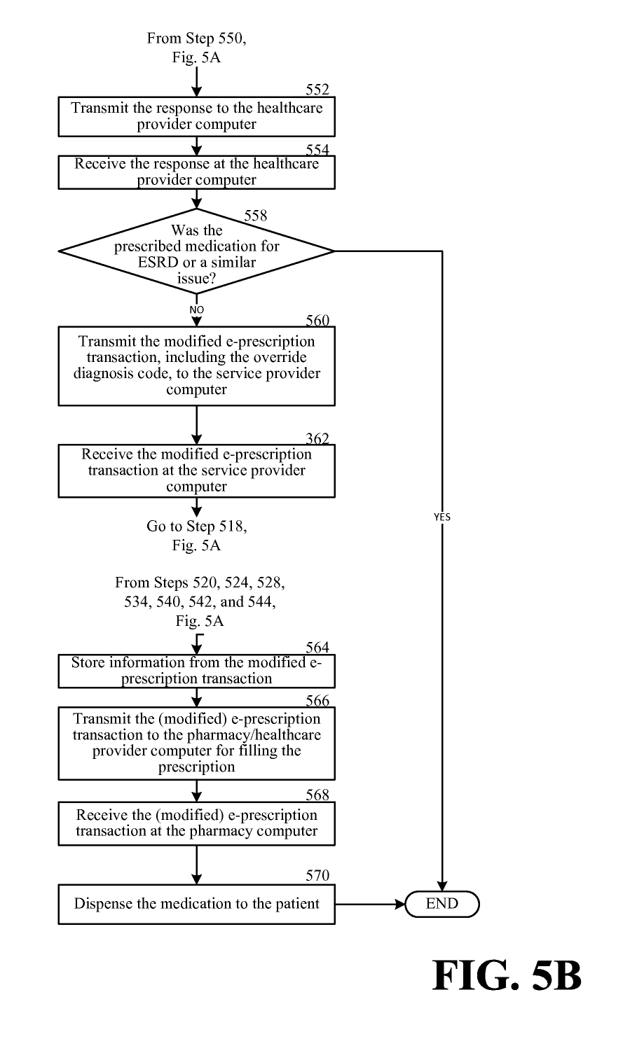

FIG. 4A is a diagram of one example data flow 400 for evaluating healthcare transactions to determine if they are for medications, products, or services related to patient care that may require a coverage determination for Medicare Part D Plans, such as ESRD, ESRD-related condition care, care for another terminal condition, or hospice care as part of the processing of the healthcare transaction through a service provider computer, such as through the service provider computer 106 illustrated in FIG. 1. FIGS. 5A-5B are flow charts of an example method 500 for evaluating healthcare transactions to determine if they are for medications, products, or services related to patient care that may require a coverage determination for Medicare Part D Plans, such as ESRD, ESRD-related condition care, care for another terminal condition, or hospice care as part of the processing of a healthcare transaction (such as a predetermination of benefits transaction, a healthcare claim transaction, prescription claim or billing request, healthcare order transaction, or e-prescription transaction (e.g., electronic prescription order transaction, e-script, or e-prescription)) for that patient through a service provider computer, in accordance with one exemplary embodiment. All or a portion of the steps in the exemplary method 500, described below, may be performed by a suitable service provider computer 106 and/or terminal care assessment module 180. The exemplary method 500 will be described with reference to a prescriber (e.g., physician, nurse, nurse practitioner, hospital or any other person permitted to prescribe medications, products, or services to patients) as one healthcare provider (and accordingly a prescriber computer as the first healthcare provider computer 104B and a pharmacy as another healthcare provider (and accordingly a pharmacy computer as another healthcare provider computer 104A). However, this is only for purposes of example as other healthcare providers could be substituted for, and should each be individually read as being a part of this method. As such, where the discussion of the methods below and the drawings state a prescriber and/or a pharmacy, any other healthcare provider could be substituted, such as a physician, hospital, physician's office, clinic, or healthcare center.

In addition, the exemplary method 500 will be described with reference to a e-prescription transaction; however, this also is only for purposes of example as other healthcare transactions, which may include, for example, a predetermination of benefits transaction, the healthcare claim transaction, prescription claim or billing request, healthcare order transaction, or e-prescription transaction (e.g., electronic prescription order transaction, e-script, or e-prescription) could be substituted for the e-prescription transaction and each form of healthcare transaction should each individually be read as being used in the method described below.

Referring now to FIGS. 1, 4A, and 5A-B, the exemplary method 500 begins at the START step and proceeds to step 502, where the service provider computer 106 can receive an eligibility messaging services file 202 from, for example, one or more claims processor computers 108 or the insurance provider, pharmacy benefits manager, Medicare Part D provider or other entity represented by the claims processor associated with the claims processor computer 108. In one example embodiment, the eligibility messaging services file 202 can include a table, list, or schedule of patients and/or patient identifiers (e.g., patient first name, patient last name, patient date of birth, patient gender, patient address, patient social security number, patient HICN, insurance cardholder name, and/or insurance person code) that identifies patients receiving patient care that may require a coverage determination for Medicare Part D Plans, such as ESRD, ESRD-related condition care, care for another terminal condition, or hospice care. In addition, the eligibility messaging services file 202 can include a table, list, or schedule of medications, products, and or services that are typically provided only by hospice care or for ESRD or ESRD-related condition care or care for another terminal condition for the patient. In one example embodiment, the medications for patient care that may require a coverage determination for Medicare Part D Plans, such as ESRD, ESRD-related condition care, care for another terminal condition, or hospice care, include, but are not limited to antiemetic medications, anti-infective medications (including antibacterial and antifungal medications), antipruritic medications (including antibacterial and antifungal medications), anxiolytic medications, excess fluid management medications, fluid and electrolyte management and volume expander medications (including intravenous medications/fluids used to treat fluid and electrolyte needs), and pain management medications (including pain management overdoes treatment medications). While the example embodiment shows one file 202 being received, in certain example embodiments, multiple files can be received by the service provider computer 106 from multiple claims processor computers 108 or those represented by the claims processor computer 108. The eligibility messaging services files 202 can be received electronically or via paper and entered into an electronic file for the database 182 or data files 148. Further, while the example embodiment shows the eligibility messaging services file 202 being received once, this is for example only, as these files 202 can be received and updated daily, weekly, monthly, quarterly, annually, or any other constant or variable time period.

In step 504, the service provider computer 106 can configure the evaluation rules for the healthcare transactions to evaluate for patient care that may require a coverage determination for Medicare Part D Plans, such as ESRD, ESRD-related condition care, care for another terminal condition, or hospice care, for the claims processor computers 108. For example, the service provider computer 106 can be configured to determine, for each claims processor computer 108, whether diagnosis code information should be included in the e-prescription transaction before transmitting the e-prescription transaction to the pharmacy/healthcare provider computer 104A, the medication identifiers for the medications that are excluded (e.g., considered to be for patient care that may require a coverage determination for Medicare Part D Plans, such as ESRD, ESRD-related condition care, care for another terminal condition, or hospice care, and for which the claims processor will not generally pay any portion of a claim, and the messages for the particular claims processor computer 108 that will be included in responses generated by the service provider computer 106 and transmitted back to the prescriber/healthcare provider computer 104B. In certain example embodiments, the configuration information for the claims processor computers 108 can be stored in the database 182 and/or the data files 148.

In step 506, a prescriber, such as a physician, nurse, nurse practitioner, physician's assistant or any other person permitted to prescribe medications, products, or services to patients, can generate an e-prescription transaction 404 at the prescriber/healthcare provider computer 104B. The physician, for example, determines the patient's name and accesses the prescriber/healthcare provider computer 104B, which receives a selection of patient information from the prescriber via the I/O interface 128B in step 508. For example, the physician accesses the prescriber/healthcare provider computer 104B and accesses a database of patient information, which may be stored in memory 126B or in another database either local or remote from the prescriber/healthcare provider computer 104B. The physician can then select the name or other patient identification information in the patient information database that matches the name or other identification information of the patient.

In step 510, a first e-prescription transaction 404 is formatted at the prescriber/healthcare provider computer 104B. In certain exemplary embodiments, the prescriber/healthcare provider computer 104B formats the first e-prescription transaction 404 with patient information (e.g., patient identifiers), pharmacy identifiers, and medication information (e.g., medication identifiers). The information can be input into the first e-prescription transaction 404 by the physician via the I/O interface 128B or automatically retrieved and entered by the prescriber/healthcare provider computer 104B and, in certain situations, can be based at least in part on historical transaction information for the patient in the data files 132B or a database communicably coupled to the prescriber/healthcare provider computer 104B. According to one example embodiment, the first e-prescription transaction 404 may be formatted in accordance with a version of the NCPDP Script Standard, although other standards, such as ANSI ASC X-12 Standard, Health Level 7 (HL7) Standard, or NCPDP Telecommunication Standard may be utilized as well.

As discussed above, the first e-prescription transaction 404 may include a pharmacy identifier for identifying a particular pharmacy/healthcare provider computer 104A as a destination for the first e-prescription transaction 404. In addition, the first e-prescription transaction 404 may also include information relating to the patient, payor, prescriber, healthcare provider, and/or the requested medication. As an example, the first e-prescription transaction 404 may include one or more of the following information:

Payor ID/Routing Information
BIN Number, BIN Number and PCN and/or BIN Number and Group ID, that designates a destination payor of the healthcare claim transaction 206

Patient Information
Name (e.g. Patient Last Name, Patient First Name, etc.)
Date of Birth of Patient
Age of Patient
Gender of Patient
Patient Address (e.g. Street Address, City, State, Zip/Postal Code, etc.)
Patient Contact Information (e.g. Patient Telephone Number, Email Address, etc.)
Patient Health Condition Information
Patient ID or other identifier (e.g., Health Insurance Claim Number (HICN), Social Security Number, etc.)

Insurance/Coverage Information
Cardholder Name (e.g. Cardholder First Name, Cardholder Last Name)
Cardholder ID and/or other identifier (e.g. Person Code)
Group ID and/or Group Information

Prescriber Information
Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number, Email Address, Fax Number, etc.)
Pharmacy or other Healthcare Provider Information (e.g. Store Name, Chain Identifier, etc.)
Pharmacy or other Healthcare Provider ID (e.g. NPI code)

Claim Information
Drug, service, or product information (e.g. National Drug Code (NDC) code, RxNorm code, etc.)
Prescription/Service Reference Number
Date Prescription Written
Quantity Dispensed
Days' Supply
Diagnosis/Condition (e.g., Diagnosis Code (e.g., International Statistical Classification of Diseases and Related Health Problems (ICD) Diagnosis Code)
Pricing information for the drug/service/product (e.g. Network Price, Usual & Customary price)
Number of Refills Authorized
One or more NCPDP Message Fields
One or more Drug Utilization (DUR) Codes
Date of Service.

The first e-prescription transaction 404 can be used to transmit a prescription from a prescriber to a pharmacy for filling of the prescription. The prescriber/healthcare provider computer 104B can transmit the first e-prescription transaction 404 to the service provider computer 106 in step 512. In step 514, the service provider computer 106 receives the first e-prescription transaction 404. For example, the first e-prescription transaction 404 can be transmitted by the prescriber/healthcare provider computer 104B to the service provider computer 106 through the network 110. The service provider computer 106 conducts any pre-editing, if necessary, on the first e-prescription transaction 404 in step 514. The pre-edits may include verifying, adding, and/or editing information included in the first e-prescription transaction 404 prior to it being communicated to a pharmacy/healthcare provider computer 104A. For example, the service provider computer 106 can parse the first e-prescription transaction 404 to determine/edit the financial fields, the service code, the quantity dispensed, and or the patient age.

In step 518, the transaction code in the first e-prescription transaction 404 can be identified. The transaction code can be an alphanumeric code that identifies the type of transaction and can be included in an agreed-upon field of the first e-prescription transaction 404. In one example embodiment, the transaction code can be identified by the terminal care assessment module 180 or another portion of the service provider computer 106 based on a review of the data in the first e-prescription transaction 404. In step 520, an inquiry is conducted to determine if the transaction code identifies the transaction 404 as an e-prescription transaction or a billing transaction. In one example embodiment, the terminal care assessment module 180 or another portion of the service provider computer 106 can determine if the transaction code identifies the transaction 404 as an e-prescription transaction, a billing transaction, or another type of transaction. For example, the terminal care assessment module 180 can compare the identified transaction code to a table, schedule, or list of transaction codes to determine if the identified transaction code matches a transaction code for an e-prescription transaction, a billing transaction, or some other type of transaction. If the identified transaction code does not identify the transaction as an e-prescription transaction or a billing transaction, the NO branch can be followed to the END step or to step 564 of FIG. 5B if the identified transaction type is one that is to be transmitted to the pharmacy/healthcare provider computer 104A or a claims processor computer 108. On the other hand, if the identified transaction code is for an e-prescription transaction or a billing transaction, the YES branch is followed to step 522.

In step 522, the one or more pharmacy identifiers in the first e-prescription transaction 404 can be identified. For example, the pharmacy identifier can be the NPI code for the pharmacy. Additional pharmacy identifiers can be the pharmacy name, pharmacy address, pharmacy contact information, and the chain identifier and chain name for the pharmacy that is to receive the e-prescription transaction 404. In one example embodiment, the one or more pharmacy identifiers can be identified by the terminal care assessment module 180 or another portion of the service provider computer 106 based on a review of the data in the first e-prescription transaction 404. In step 524, an inquiry is conducted to determine if the pharmacy identifier identifies the pharmacy as one for which ESRD, terminal care, and hospice care assessment of healthcare transactions is being completed. For example, the pharmacy or the chain to which the pharmacy belongs, can sign up to have the transactions evaluated for ESRD, terminal care, and hospice care potential to reduce the possibility that it will subsequently be determined that the claims processor identified in the e-prescription transaction 404 should not have paid for the medication, product, or service requested therein because it was for patient care that may require a coverage determination for Medicare Part D Plans, such as ESRD, ESRD-related condition care, care for another terminal condition, or hospice care. In one example embodiment, the terminal care assessment module 180 or another portion of the service provider computer 106 can determine if the pharmacy identifier identifies the receiving pharmacy as one that is receiving ESRD, terminal care, and hospice care assessment services. For example, the terminal care assessment module 180 can compare the identified pharmacy identifier to a table, schedule, or list of pharmacy identifiers to determine if the identified pharmacy identifier matches a stored pharmacy identifier representing a pharmacy receiving ESRD, terminal care, and hospice assessment of healthcare transactions. If the identified pharmacy identifier does not identify a pharmacy receiving ESRD, terminal care, and hospice care assessment of healthcare transactions, the NO branch can be followed to step 564 of FIG. 5B. Otherwise, the YES branch is followed to step 526.

In step 526, the one or more claims processor/payor identifiers in the first e-prescription transaction 404 can be identified. For example, the claims processor identifier can be the BIN Number, BIN Number and PCN, or BIN Number and Group ID. In one example embodiment, the claims processor identifier can be identified by the terminal care assessment module 180 or another portion of the service provider computer 106 based on a review of the data in the first e-prescription transaction 404. In step 528, an inquiry is conducted to determine if the claims processor identifier identifies the claims processor (e.g., PBM, payor, healthcare insurance company, Medicare or other government healthcare insurance payor, Medicare Part D provider, etc.) as one for which ESRD, terminal care, and hospice care assessment of healthcare transactions is being completed. For example, the claims processor can sign up to have the transactions evaluated for ESRD, terminal care, and hospice care potential to reduce the possibility that it will subsequently be determined that the claims processor identified in the first e-prescription transaction 404 should not have paid for the medication, product, or service requested therein because it was for patient care that may require a coverage determination for Medicare Part D Plans, such as ESRD, ESRD-related condition care, care for another terminal condition, or hospice care. In one example embodiment, the terminal care assessment module 180 or another portion of the service provider computer 106 can determine if the claims processor identifier identifies the claims processor as one that is receiving ESRD, terminal care, and hospice care assessment services. For example, the terminal care assessment module 180 can compare the identified claims processor identifier to a table, schedule, or list of stored claims processor identifiers to determine if the identified claims processor identifier matches a stored claims processor identifier representing a claims processor receiving ESRD, terminal care, and hospice assessment of healthcare transactions. If the identified claims processor identifier does not identify a claims processor receiving ESRD, terminal care, and hospice care assessment of healthcare transactions, the NO branch can be followed to step 564 of FIG. 5B. Otherwise, the YES branch is followed to step 530.

In step 530, the one or more patient identifiers in the first e-prescription transaction 404 can be identified. For example, the patient identifiers can be the Cardholder Name (e.g., cardholder first name and last name (which can be different from the patient's first and last name) on the patient's insurance card) and Cardholder ID (e.g., person code on the patient's insurance card). In addition, or in the alternative, the patient identifiers can be one or more of the patient first name, patient last name, patient gender, patient date of birth, patient address, patient contact information (e.g., phone number or email address), patient social security number, and/or patient HICN. In one example embodiment, the one or more patient identifiers can be identified by the terminal care assessment module 180 or another portion of the service provider computer 106 based on a review of the data in the first e-prescription transaction 404. In step 532, the identified one or more patient identifiers can be compared to a table, schedule, or listing of patient identifiers for patients receiving patient care that may require a coverage determination for Medicare Part D Plans, such as ESRD, ESRD-related condition care, care for another terminal condition, or hospice care. In certain example embodiments, the list of patient identifiers for patients receiving patient care that may require a coverage determination for Medicare Part D Plans, such as ESRD, ESRD-related condition care, care for another terminal condition, or hospice care, can be based on the list of patients in the eligibility messaging services file 202 received from the claims processor, as discussed in step 502. In one example embodiment, the comparison can be made by the terminal care assessment module 180 or another portion of the service provider computer 106.

In step 534, an inquiry is conducted to determine if the identified one or more patient identifiers matches one or more of the patient identifiers in the table, schedule, or listing of identifiers for patients receiving patient care that may require a coverage determination for Medicare Part D Plans, such as ESRD, ESRD-related condition care, care for another terminal condition, or hospice care. In one example embodiment, the terminal care assessment module 180 or another portion of the service provider computer 106 can determine if a match exists. If the identified one or more patient identifiers does not match a patient identifier for a patient receiving patient care that may require a coverage determination for Medicare Part D Plans, such as ESRD, ESRD-related condition care, care for another terminal condition, or hospice care, the NO branch can be followed to step 564 of FIG. 5B. Otherwise, the YES branch can be followed to step 536.

In step 536, the identifier for the medication, product, or service being requested in the first e-prescription transaction 404 (hereinafter, the medication identifier) can be identified. For example, the medication identifier can be the NDC code or RxNorm number for the medication, product, or service. In addition, or in the alternative, the medication identifier can be the name of the medication, product, or service. In one example embodiment, the medication identifier can be identified by the terminal care assessment module 180 or another portion of the service provider computer 106 based on a review of the data in the first e-prescription transaction 404. In step 538, the identified medication identifier can be compared to a table, schedule, or listing of medication identifiers for excluded medications (e.g., medications, products, or services for which the claims processor will not pay any portion of the cost because they are medications typically provided to patients for patient care that may require a coverage determination for Medicare Part D Plans, such as ESRD, ESRD-related condition care, care for another terminal condition, or hospice care. In certain example embodiments, the list of medication identifiers for excluded medications can be based on the medication identifiers received in the eligibility messaging services file 202 received from the claims processor, as discussed in step 502. In one example embodiment, the comparison can be made by the terminal care assessment module 180 or another portion of the service provider computer 106.

In step 540, an inquiry is conducted to determine if the identified medication identifier matches one or more of the medication identifiers in the table, schedule, or listing of medication identifiers for excluded medications. In one example embodiment, the terminal care assessment module 180 or another portion of the service provider computer 106 can determine if a match exists. If the identified medication identifier does not match a medication identifier for an excluded medication, the NO branch can be followed to step 564 of FIG. 5B. Otherwise, the YES branch is followed to step 542.

In step 542, an inquiry is conducted to determine if the first e-prescription transaction 404 was previously validated. In one example embodiment, the determination can be made by the terminal care assessment module 180 or another portion of the service provider computer 106. For example, the terminal care assessment module 180 can compare the prescription number for the first e-prescription transaction 404 to a table, schedule, or listing of prescription numbers (e.g., in the database 182 or data files 148) for e-prescription transactions that have been previously validated (e.g., the requested medication, product, or service, for the identified patient in the transaction 404 has previously been verified to not be for patient care that may require a coverage determination for Medicare Part D Plans, such as ESRD, ESRD-related condition care, care for another terminal condition, or hospice care) to determine if a match exists. If a match does exist, the YES branch can be followed to step 564 of FIG. 5B. On the other hand, if a match does not exist, the NO branch can be followed to step 544.

In step 544, an inquiry is conducted to determine if the first e-prescription transaction 404 includes an override code. The determination can be made by the terminal care assessment module 180 or another portion of the service provider computer 106. For example, the terminal care assessment module 180 can parse the first e-prescription transaction 404 and review the override code field in the transaction 404 to determine if it includes an override code and if that override code is one that identifies the medication, product, or service requested in the transaction 404 as not being for patient care that may require a coverage determination for Medicare Part D Plans, such as ESRD, ESRD-related condition care, care for another terminal condition, or hospice care. In an alternative embodiment, the override code can be a diagnosis code identifying a diagnosis for the ailment currently affecting the patient and can be found in the diagnosis code field of the first e-prescription transaction 404. In this alternative embodiment, the diagnosis code can be compared to a table, schedule, or listing of diagnosis codes that are for an ailment that is not related to patient care that may require a coverage determination for Medicare Part D Plans, such as ESRD, ESRD-related condition care, care for another terminal condition, or hospice care. Alternatively, the table of diagnosis codes can be for ailments related to patient care that may require a coverage determination for Medicare Part D Plans, such as ESRD, ESRD-related condition care, care for another terminal condition, or hospice care, in which case the YES and NO branches discussed below would be reversed. In certain example embodiments, the terminal care override code could have been previously provided to the prescriber/healthcare provider computer 104B by the service provider computer 106. If a determination is made that the first e-prescription transaction 404 includes a proper override code (the override code matches one or more override codes that identifies the medication, product, or service requested in the transaction 404 as not being for patient care that may require a coverage determination for Medicare Part D Plans, such as ESRD, ESRD-related condition care, care for another terminal condition, or hospice care, or the override code matches a diagnosis code for the patient that identifies a diagnosis that is not for patient care that may require a coverage determination for Medicare Part D Plans, such as ESRD, ESRD-related condition care, care for another terminal condition, or hospice care), then the YES branch is followed to step 564 of FIG. 5B. Otherwise, the NO branch is followed to step 546.

In step 546, the first e-prescription transaction 404 is rejected and/or a response is generated back to the prescriber/healthcare provider computer 104B. In one example embodiment, the response/rejection 406 (hereinafter referred to as a response) to the first e-prescription transaction 404 can be generated by the terminal care assessment module 180 or another portion of the service provider computer 106 without sending the transaction 404 to the pharmacy/healthcare provider computer 104A. In step 548, the terminal care assessment module 180 or another portion of the service provider computer 106 can insert the reject code, and optionally the reject message, into the response to the first e-prescription transaction 406. For example, the reject code can include code “A4 (this product may be covered under the Medicare-B bundled payment to an ESRD dialysis facility.” In addition, the rejection message could state, for example, “ESRD patient and Rx may be ESRD related. Document Rx is ‘Not ESRD related or Rx, place ‘NR2ESRD’ in diagnosis code field and resubmit. If ‘ESRD related’ direct patient to dialysis facility for medication or process as ‘cash transaction’.” The response to the first e-prescription transaction 406 may also include an override code that can be used by the physician or other prescriber when submitting a modified e-prescription transaction 408.

In step 550, all or a portion of the information from the first e-prescription transaction 404 and/or the response to the first e-prescription transaction 406 can be stored for subsequent evaluation. For example, the information can be stored in the database 182 and/or the data files 148 and can include, but is not limited to, the prescription number, the medication identifier, the one or more patient identifiers, and the pharmacy identifier. In one example embodiment, the information from the first e-prescription transaction 404 and/or the response 406 can be stored by the terminal care assessment module 180 or another portion of the service provider computer 106. In step 552, the response to the first e-prescription transaction 406 can be transmitted to the prescriber/healthcare provider computer 104B. For example, the service provider computer 106 can transmit the response 406 via the network 110 to the prescriber/healthcare provider computer 104B.

The prescriber/healthcare provider computer 104B can receive the response to the first e-prescription transaction 406, which includes the rejection by the service provider computer 106, in step 554. In step 558, an inquiry is conducted to determine if the requested medication, product, or service is for patient care that may require a coverage determination for Medicare Part D Plans, such as ESRD, ESRD-related condition care, care for another terminal condition, or hospice care. If the physician or other prescriber prescribed the medication, product, or service for patient care that may require a coverage determination for Medicare Part D Plans, such as ESRD, ESRD-related condition care, care for another terminal condition, or hospice care, the YES branch can be followed to the END step. Otherwise, the NO branch can be followed to step 560.

In step 560, the physician or other prescriber can generate a modified e-prescription transaction 408 and the prescriber/healthcare provider computer 104B can transmit the modified e-prescription transaction 408 to the service provider computer 106 via, for example, the network 110. For example, the modified e-prescription transaction 408 can include the override diagnosis code that was previously provided to the prescriber/healthcare provider computer 104B in the response to the first e-prescription transaction 406. In this example, the override diagnosis code can be placed into an agreed upon field of the modified e-prescription transaction 408, such as the diagnosis code field. Further, in certain example embodiments, the prescription number, medication identifier, pharmacy identifier, claims processor identifier, and one or more patient identifiers in the modified e-prescription transaction 408 and the first e-prescription transaction 404 can be the same. In step 562, the service provider computer 106 receives the modified e-prescription transaction 408 from the prescriber/healthcare provider computer 104B. The process then returns to step 518, where steps 518-562 may be repeated for the modified e-prescription transaction 408 in a manner substantially the same as that discussed above for the first e-prescription transaction 404, as one of ordinary skill in the art will recognize. For example, in such a situation, in step 544, the terminal care assessment module 180 may determine that the modified e-prescription transaction 408 includes an override diagnosis code in the diagnosis code or override field of the modified e-prescription transaction 408 and may further determine that the diagnosis code matches an override diagnosis code or is a diagnosis for the patient that is not related to patient care that may require a coverage determination for Medicare Part D Plans, such as ESRD, ESRD-related condition care, care for another terminal condition, or hospice care. Based on that determination, the process may proceed to step 564 of FIG. 5B.

In step 564, information from the first e-prescription transaction 404 or the modified e-prescription transaction 408 can be stored in, for example, the database 182 or the data files 148. For example, the terminal care assessment module 180 or another portion of the service provider computer 106 can store the prescription number, the medication identifier, the one or more patient identifiers, the pharmacy identifier, and the claims processor identifier.

The service provider computer 106 can transmit the first e-prescription transaction 404 or the modified e-prescription transaction 408 to the pharmacy/healthcare provider computer 104A in step 566. For example, a first e-prescription transaction 404 or modified e-prescription transaction 408 can be transmitted from the service provider computer 106 to the pharmacy/healthcare provider computer 104A via the network 110. The pharmacy/healthcare provider computer 104A receives the first e-prescription transaction 404 or the modified e-prescription transaction 408 in step 568. In step 570, the pharmacy, such as a pharmacist or other pharmacy employee can dispense the medication to the patient based on information in the e-prescription transaction 404 or the modified e-prescription transaction 408. The process then continues to the END step.

The methods described and shown in FIGS. 3A-5B may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 3A-5B may be performed.

Likewise, while FIGS. 3A-B and 5A-B have been described primarily in conjunction with FIGS. 2A and 4A respectively, it will be appreciated that variations of FIGS. 2A and 4A are available. As shown by FIGS. 2B and 4B, the service provider computer 106 may include two or more distinct service provider computers 106a and 106b that are in communication with each other. These distinct service provider computers 106a and 106b may be owned, operated, and or located by the same or distinct and wholly-unrelated companies. The service provider computer 106a may be operative with the pharmacy/healthcare provider computer 104A (FIG. 2B) and the prescriber/healthcare provider computer 104B (FIG. 4B), while the service provider computer 106b may be operative with other healthcare provider computers and/or other third-party entity computers. However, the service provider computer 106b may have a data processing arrangement with the service provider computer 106a. Under the data processing arrangement, the service provider computer 106a may be permitted to utilize or offer services of the service provider computer 106b, including the operations and use of the terminal care assessment module 180 and/or the database 182 to conduct ESRD, terminal care, and hospice care assessments for healthcare transactions, as discussed above in FIGS. 3A-B and 5A-B. Accordingly, the services accessible by the service provider computer 106b, including the ESRD, terminal care, and hospice care assessments of medications, products, or services requested in healthcare transactions, may be available to the pharmacy/healthcare provider computer 104A (FIG. 2B) and the prescriber/healthcare provider computer 104B (FIG. 4B) via the service provider computers 106a and 106b.

Accordingly, example embodiments disclosed herein can provide the technical effects of creating a system and methods that provide a real-time or near real time way to evaluate healthcare transactions to determine if they include requests for medications, products, or services associated with patient care that may require a coverage determination for Medicare Part D Plans, such as ESRD, ESRD-related condition care, care for another terminal condition, or hospice care. In this regard, pharmacies and other healthcare providers are less likely to improperly request and claims processors are less likely to improperly pay for medications, products, or services for patients when those medications, products, or services are being requested as part of patient care that may require a coverage determination for Medicare Part D Plans, such as ESRD, ESRD-related condition care, care for another terminal condition, or hospice care.

While certain example embodiments disclosed herein describe the terminal care assessment module 180 as being separate of the service provider computer 106, in alternate embodiments, the terminal care assessment module 180 or the functions that it completes may be part of the service provider computer 106. In those embodiments where the terminal care assessment module 180 is incorporated into the service provider computer 106, and with regard to the methods described above, the steps describing transmitting or receiving between the service provider computer 106 and the terminal care assessment module 180 may be internal transmissions within the service provider computer 106 or may be omitted altogether. Further, while the exemplary embodiments described herein disclose certain steps occurring at the service provider computer 106 and/or the terminal care assessment module 180, in alternative embodiments those steps described with reference to FIGS. 1-5B may alternately be completed at a pharmacy/healthcare provider computer 104A, a prescriber/healthcare provider computer 104B, or another healthcare provider computer 104 (e.g., a hospital computer, clinic computer, etc.) a claims processor computer 108, an terminal care assessment module 180, any combination thereof, and/or a combination of those devices along with the service provider computer 106. In those alternate embodiments, certain transmission/receiving steps described above with reference to FIGS. 1-5B may be omitted while others may be added, as understood by one or ordinary skill in the art. The intent being that in alternate embodiments, any of the devices/computers discussed in FIG. 1 are capable of completing any or any part of the methods described with reference to FIGS. 2A-5B.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, that includes a computer usable medium (e.g., transitory or non-transitory) having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer-implemented method, comprising:
receiving, by one or more service provider computers associated with a service provider and comprising one or more processors from a healthcare provider computer associated with a healthcare provider, a healthcare transaction comprising healthcare transaction data, wherein the healthcare transaction data comprises a medication identifier identifying a medication to be prescribed and at least one patient identifier identifying a patient to receive the prescribed medication;
identifying, by the one or more service provider computers, the healthcare transaction data in the healthcare transaction;
determining, by the one or more service provider computers and based on the identified healthcare transaction data, if the healthcare transaction is for a medication for at least one of the end stage renal disease (ESRD) care for the patient or hospice care for the patient;
generating, by the one or more service provider computers and based at least in part on the positive determination that the healthcare transaction is for a medication for at least one of the ESRD care for the patient or hospice care for the patient, a rejection response to the healthcare transaction; and
transmitting, by the one or more service provider computers, the rejection response to the healthcare transaction to the healthcare provider computer.

2. The computer-implemented method of claim 1, wherein the rejection response comprises a request for a diagnosis code for the patient.

3. The computer-implemented method of claim 2, further comprising:
receiving, by the one or more service provider computers from the healthcare provider computer, a modified healthcare transaction comprising modified healthcare transaction data, wherein the modified healthcare transaction data comprises the medication identifier, the at least one patient identifier identifying the patient, and the diagnosis code for the patient;
identifying, by the one or more service provider computers, the modified healthcare transaction data in the modified healthcare transaction;
determining, by the one or more service provider computers, based on the identified diagnosis code for the patient if the modified healthcare transaction is for a medication for at least one of the ESRD care for the patient or hospice care for the patient; and
transmitting, by the one or more service provider computers and based at least in part on the negative determination that the modified healthcare transaction is for the medication for at least one of the ESRD care for the patient or hospice care for the patient, the modified healthcare transaction to one of a pharmacy computer associated with a pharmacy or a claims processor computer associated with a claims processor.

4. The computer-implemented method of claim 3, further comprising:
generating, by the one or more service provider computers and based at least in part on the positive determination that the modified healthcare transaction is for the medication for at least one of the ESRD care for the patient or hospice care for the patient, a second rejection response to the modified healthcare transaction; and
transmitting, by the one or more service provider computers, the second rejection response to the modified healthcare transaction to the healthcare provider computer.

5. The computer-implemented method of claim 1, wherein determining if the healthcare transaction is for a medication for at least one of the ESRD care for the patient or hospice care for the patient comprises:
identifying, by the one or more service provider computers, the at least one patient identifier in the healthcare transaction;
comparing, by the one or more service provider computers, the at least one patient identifier to a schedule of patient identifiers identifying a plurality of patients receiving at least one of ESRD patient care and hospice care; and
determining, by the one or more service provider computers, if the at least one patient identifier matches at least one of the schedule of patient identifiers;
wherein the rejection response is generated by the service provider computer based at least in part on a positive determination that the at least one patient identifier in the healthcare transaction matches at least of the schedule of patient identifiers.

6. The computer-implemented method of claim 5, wherein determining if the healthcare transaction is for a medication for at least one of the ESRD care for the patient or hospice care for the patient further comprises:
identifying, by the one or more service provider computers, the medication identifier in the healthcare transaction;
comparing, by the one or more service provider computers, the medication identifier to a schedule of medication identifiers identifying a plurality of excluded medications, wherein the excluded medications are medications generally provided for treatment during at least one of ESRD patient care and hospice care; and
determining, by the one or more service provider computers, if the medication identifier matches at least one of the schedule of medication identifiers for excluded medications;
wherein the rejection response is generated by the service provider computer based at least in part on a positive determination that the at least one patient identifier in the healthcare transaction matches at least one of the schedule of patient identifiers and the medication identifier matches at least one of the schedule of medication identifiers for excluded medications.

7. The computer-implemented method of claim 1, further comprising inserting, by the one or more service provider computers, an override code into the rejection response prior to transmitting the rejection response to the healthcare provider computer.

8. The computer-implemented method of claim 7, further comprising:
receiving, by the one or more service provider computers from the healthcare provider computer, a modified healthcare transaction comprising modified healthcare transaction data, wherein the modified healthcare transaction data comprises the medication identifier, the at least one patient identifier identifying the patient, and the override code;
identifying, by the one or more service provider computers, the override code in the modified healthcare transaction data;
determining, by the one or more service provider computers, that the override code is a valid override code; and
transmitting, by the one or more service provider computers and based at least in part on the positive determination that the override code is the valid override code, the modified healthcare transaction to one of a pharmacy computer associated with a pharmacy or a claims processor computer associated with a claims processor.

9. The computer-implemented method of claim 1, wherein determining if the healthcare transaction is for a medication for at least one of the ESRD care for the patient or hospice care for the patient further comprises:
identifying, by the one or more service provider computers, the medication identifier in the healthcare transaction;
comparing, by the one or more service provider computers, the medication identifier to a schedule of medication identifiers identifying a plurality of excluded medications, wherein the excluded medications are medications generally provided for treatment during at least one of ESRD patient care and hospice care; and
determining, by the one or more service provider computers, if the medication identifier matches at least one of the schedule of medication identifiers for excluded medications;
wherein the rejection response is generated by the service provider computer based at least in part on a positive determination that the medication identifier matches at least one of the schedule of medication identifiers for excluded medications.

10. The computer-implemented method of claim 1, further comprising:
receiving, by the one or more service provider computers, a schedule of patient identifiers identifying a plurality of patients receiving at least one of ESRD patient care and hospice care; and
storing, by the one or more service provider computers, the schedule of patient identifiers.

11. A system, comprising;
at least one memory operable to store computer-executable instructions; and
at least one processor configured to access the at least one memory and execute the computer-executable instructions to:
receive, from a healthcare provider computer associated with a healthcare provider, a healthcare transaction comprising healthcare transaction data, wherein the healthcare transaction data comprises a medication identifier identifying a medication to be prescribed and at least one patient identifier identifying a patient to receive the prescribed medication;
identify the healthcare transaction data in the healthcare transaction;
determine, based on the identified healthcare transaction data, if the healthcare transaction is for a medication for at least one of the ESRD care for the patient or hospice care for the patient;
generate, based at least in part on the positive determination that the healthcare transaction is for a medication for at least one of the ESRD care for the patient or hospice care for the patient, a rejection response to the healthcare transaction; and
direct communication of the rejection response to the healthcare transaction to the healthcare provider computer.

12. The system of claim 11, wherein the rejection response comprises a request for a diagnosis code for the patient.

13. The system of claim 12, wherein the at least one processor is configured to access the at least one memory and execute the computer-executable instructions to:
receive, from the healthcare provider computer, a modified healthcare transaction comprising modified healthcare transaction data, wherein the modified healthcare transaction data comprises the medication identifier, the at least one patient identifier identifying the patient, and the diagnosis code for the patient;
identify the modified healthcare transaction data in the modified healthcare transaction;
determine, based on the identified diagnosis code for the patient, if the modified healthcare transaction is for a medication for at least one of the ESRD care for the patient or hospice care for the patient; and
direct communication of the modified healthcare transaction to one of a pharmacy computer associated with a pharmacy or a claims processor computer associated with a claims processor based at least in part on the negative determination that the modified healthcare transaction is for the medication for at least one of the ESRD care for the patient or hospice care for the patient.

14. The system of claim 13, wherein the at least one processor is configured to access the at least one memory and execute the computer-executable instructions to:
generate, based at least in part on the positive determination that the modified healthcare transaction is for the medication for at least one of the ESRD care for the patient or hospice care for the patient, a second rejection response to the modified healthcare transaction; and
direct communication of the second rejection response to the healthcare provider computer.

15. The system of claim 11, wherein the at least one processor is configured to determine if the healthcare transaction is for a medication for at least one of the ESRD care for the patient or hospice care for the patient by accessing the at least one memory and execute the computer-executable instructions to:
identify the at least one patient identifier in the healthcare transaction;
compare the at least one patient identifier to a schedule of patient identifiers identifying a plurality of patients receiving at least one of ESRD patient care and hospice care; and
determine if the at least one patient identifier matches at least one of the schedule of patient identifiers;
wherein the rejection response is generated based at least in part on a positive determination that the at least one patient identifier in the healthcare transaction matches at least of the schedule of patient identifiers.

16. The system of claim 15, wherein the at least one processor is configured to determine if the healthcare transaction is for a medication for at least one of the ESRD care for the patient or hospice care for the patient by accessing the at least one memory and execute the computer-executable instructions to:
identify the medication identifier in the healthcare transaction;
compare the medication identifier to a schedule of medication identifiers identifying a plurality of excluded medications, wherein the excluded medications are medications generally provided for treatment during at least one of ESRD patient care and hospice care; and
determine if the medication identifier matches at least one of the schedule of medication identifiers for excluded medications;
wherein the rejection response is generated based at least in part on a positive determination that the at least one patient identifier in the healthcare transaction matches at least one of the schedule of patient identifiers and the medication identifier matches at least one of the schedule of medication identifiers for excluded medications.

17. The system of claim 11, wherein the at least one processor is configured to access the at least one memory and execute the computer-executable instructions to insert an override code into the rejection response prior to transmitting the rejection response to the healthcare provider computer.

18. The system of claim 17, wherein the at least one processor is configured to access the at least one memory and execute the computer-executable instructions to:
receive, from the healthcare provider computer, a modified healthcare transaction comprising modified healthcare transaction data, wherein the modified healthcare transaction data comprises the medication identifier, the at least one patient identifier identifying the patient, and the override code;
identify the override code in the modified healthcare transaction data;
determine that the override code is a valid override code; and
direct communication of the modified healthcare transaction to one of a pharmacy computer associated with a pharmacy or a claims processor computer associated with a claims processor based at least in part on the positive determination that the override code is the valid override code.

19. The system of claim 11, wherein the at least one processor is configured to determine if the healthcare transaction is for a medication for at least one of the ESRD care for the patient or hospice care for the patient by accessing the at least one memory and execute the computer-executable instructions to:
identify the medication identifier in the healthcare transaction;
compare the medication identifier to a schedule of medication identifiers identifying a plurality of excluded medications, wherein the excluded medications are medications generally provided for treatment during at least one of ESRD patient care and hospice care; and
determine if the medication identifier matches at least one of the schedule of medication identifiers for excluded medications;
wherein the rejection response is generated based at least in part on a positive determination that the medication identifier matches at least one of the schedule of medication identifiers for excluded medications.

20. The system of claim 11, wherein the at least one processor is configured to access the at least one memory and execute the computer-executable instructions to:
receive a schedule of patient identifiers identifying a plurality of patients receiving at least one of ESRD patient care and hospice care; and
store the schedule of patient identifiers.
